(19) United States
(12) Patent Application Publication
(10) Pub. No.: US 2024/0002701 A1
(43) Pub. Date: Jan. 4, 2024

(54) PRESSURE-SENSITIVE ADHESIVE COMPOSITION, PRESSURE-SENSITIVE ADHESIVE LAYER, AND PRESSURE-SENSITIVE ADHESIVE SHEET

(71) Applicant: NITTO DENKO CORPORATION, baraki-shi, Osaka (JP)

(72) Inventors: Kensuke TANI, Ibaraki-shi, Osaka (JP); Daisuke TSUMURA, Ibaraki-shi, Osaka (JP)

(21) Appl. No.: 17/796,266

(22) PCT Filed: Jan. 27, 2021
(86) PCT No.: PCT/JP2021/002920

§ 371 Date: Jul. 29, 2022

(30) Foreign Application Priority Data
Jan. 30, 2020 (JP) 2020-013774

(51) Int. Cl. C09J 7/38; C09J 133/24

(52) U.S. Cl. CPC C09J 7/385; C09J 133/24

(57) ABSTRACT

The present invention relates to a pressure-sensitive adhesive composition containing a base polymer, in which the base polymer is a copolymer containing structures derived from a water-insoluble hydrophilic monomer (a) and a nitrogen-containing hydrophilic monomer (b), and a content ratio of the structure derived from the water-insoluble hydrophilic monomer (a) in the base polymer is 40 mass % or more.

### TECHNICAL FIELD

The present invention relates to a pressure-sensitive adhesive composition, a pressure-sensitive adhesive layer, and a pressure-sensitive adhesive sheet.

### BACKGROUND ART

Commonly, an adhesive or a pressure-sensitive adhesive has been used for adhesion and fixation in various fields, and a material that exhibits a sufficient adhesive force or pressure-sensitive adhesive force even for an adherend in a wet state in which the adhesive force is difficult to be obtained has been developed.

For example, Patent Literature 1 describes a pressure-sensitive adhesive comprising a polymerization product of a (meth)acrylate ester monomer, a hydrophilic acidic comonomer and a non-reactive plasticizing agent, which adheres quickly to wet or dry substrate surfaces, and a method of making the pressure-sensitive adhesive.

Patent Literature 2 describes a pressure-sensitive adhesive sheet that covers a surface of a cement material such as concrete, mortar, or cement. The pressure-sensitive adhesive sheet includes a pressure-sensitive adhesive containing a polymer derived from a monomer component containing alkyl (meth)acrylate having 4 to 18 carbon atoms and a monomer having at least one nitrogen-containing functional group, in which the pressure-sensitive adhesive layer is capable of adhering to a surface of the cement material in a wet state, and is capable of being peeled off from the surface of the cement material after curing.

Further, in a manufacturing process of an electronic component or an electronic device or the like, a pressure-sensitive adhesive sheet may be used to protect a member, and the pressure-sensitive adhesive sheet may be used after the electronic component or the electronic device is washed with water.

### CITATION LIST

### Patent Literature

Patent Literature 1: JP-T-2017-514005

Patent Literature 2: JP-A-2017-2132

### SUMMARY OF INVENTION

### Technical Problem

However, in Patent Literature 1, since a hydrophilic acidic comonomer is used, the hydrophilic acidic comonomer causes corrosion when used for concrete or the like. When used in the manufacture of an electronic component such as a printed wiring board or an electronic device, an adherend may be affected by an acid. Further, in the case of use after the electronic component or the electronic device is washed with water, a drying step is required.

In techniques of the related art, there have been problems such as insufficient initial adhesiveness to an adherend having a high water content or an adherend in a wet state with water, poor workability, and the like, and there is a demand for development of a pressure-sensitive adhesive sheet exhibiting sufficient adhesive force to an adherend in a wet state.

Accordingly, an object of the present invention is to provide a pressure-sensitive adhesive sheet that inhibits corrosion of an adherend and exhibits sufficient initial adhesiveness and high adhesive force to an adherend in a wet state, a pressure-sensitive adhesive composition and a pressure-sensitive adhesive layer, by which the pressure-sensitive adhesive sheet can be produced.

### Solution to Problem

As a result of intensive studies, the present inventors have found that the above problems can be solved, and have completed the present invention. That is, the present invention is as follows.
[1] A pressure-sensitive adhesive composition including a base polymer, in which
   the base polymer is a copolymer containing structures derived from a water-insoluble hydrophilic monomer (a) and a nitrogen-containing hydrophilic monomer (b), and a content ratio of the structure derived from the water-insoluble hydrophilic monomer (a) in the base polymer is 40 mass % or more.
[2] A pressure-sensitive adhesive composition including a base polymer, in which
   a pressure-sensitive adhesive layer formed of the pressure-sensitive adhesive composition has a water absorption amount of 9.0 mg or more as measured by the following method:
   Measurement method of water absorption amount: the pressure-sensitive adhesive layer having a thickness of 100 μm is attached to a PET film having a thickness of 50 μm and cut into a size of 2.5 cm×5 cm to obtain a measurement sample, and the water absorption amount is calculated from a difference between a mass of the measurement sample after immersion in pure water under the following conditions and a mass of the measurement sample before immersion:
   Immersion temperature: 23° C.
   Immersion time: 5 minutes.
[3] The pressure-sensitive adhesive composition according to [1], in which the water-insoluble hydrophilic monomer (a) is at least one selected from methoxyethyl acrylate, ethoxy-diethylene glycol acrylate, methoxy-dipropylene glycol acrylate, or methoxy-triethylene glycol acrylate.
[4] The pressure-sensitive adhesive composition according to [1] or [3], in which the nitrogen-containing hydrophilic monomer (b) is at least one selected from N-vinyl-2-pyrrolidone, hydroxyethyl acrylamide, acryloyl morpholine, vinyl formamide, or vinyl acetamide.
[5] The pressure-sensitive adhesive composition according to any one of [1] to [4], further including a crosslinking agent, in which the crosslinking agent is at least one selected from a photocuring agent or an isocyanate compound.
[6] The pressure-sensitive adhesive composition according to [5], in which the photocuring agent is a photocurable monomer or a photocurable oligomer.
[7] A pressure-sensitive adhesive layer formed of the pressure-sensitive adhesive composition according to any one of [1] to [6].
[8] The pressure-sensitive adhesive layer according to [7], in which a swelling degree after immersion in water at 5° C. for 24 hours is 2.5 to 10, and a swelling degree after immersion in water at 23° C. for 24 hours is 1.0 to 2.5.
[9] A pressure-sensitive adhesive sheet including the pressure-sensitive adhesive layer according to [7] or [8].
[10] The pressure-sensitive adhesive sheet according to [9], in which the pressure-sensitive adhesive layer is formed on a substrate.

### Advantageous Effects of Invention

According to the present invention, it is possible to provide a pressure-sensitive adhesive sheet that exhibits sufficient initial adhesiveness and high adhesive force to an adherend in a wet state and can inhibit corrosion of the adherend, and a pressure-sensitive adhesive composition and a pressure-sensitive adhesive layer, by which the pressure-sensitive adhesive sheet can be produced.

### BRIEF DESCRIPTION OF DRAWINGS

FIG. 1 is an example of a schematic cross-sectional view of a pressure-sensitive adhesive sheet according to an embodiment of the present invention.

FIG. 2 is an example of a schematic cross-sectional view of a pressure-sensitive adhesive sheet according to an embodiment of the present invention.

FIG. 3 is an example of a schematic cross-sectional view of a pressure-sensitive adhesive sheet according to an embodiment of the present invention.

### DESCRIPTION OF EMBODIMENTS

Hereinafter, embodiments of the present invention will be described in detail. The present invention is not limited to the embodiments to be described below.

### [Pressure-Sensitive Adhesive Composition]

A pressure-sensitive adhesive composition according to an embodiment of the present invention is a pressure-sensitive adhesive composition containing a base polymer, in which the base polymer is a copolymer containing structures derived from a water-insoluble hydrophilic monomer (a) and a nitrogen-containing hydrophilic monomer (b), and a content ratio of the structure derived from the water-insoluble hydrophilic monomer (a) in the base polymer is 40 mass % or more.

A pressure-sensitive adhesive composition according to another embodiment of the present invention is a pressure-sensitive adhesive composition containing a base polymer, in which a pressure-sensitive adhesive layer formed of the pressure-sensitive adhesive composition has a water absorption amount of 9.0 mg or more as measured by the following method.

Measurement method of water absorption amount: the pressure-sensitive adhesive layer having a thickness of 100 μm is attached to a PET film having a thickness of 50 μm and cut into a size of 2.5 cm×5 cm to obtain a measurement sample, and the water absorption amount is calculated from a difference between a mass of the measurement sample after immersion in pure water under the following conditions and a mass of the measurement sample before immersion.

Immersion temperature: 23° C.

Immersion time: 5 minutes

### (Base Polymer)

The base polymer in the pressure-sensitive adhesive composition according to the present embodiment refers to a main component of a polymer contained in the pressure-sensitive adhesive composition. In this specification, the term “main component” refers to a component contained in an amount of more than 50 mass %, unless otherwise specified.

The base polymer used in the pressure-sensitive adhesive composition according to the present embodiment may be a temperature-responsive polymer.

The temperature-responsive polymer refers to a polymer in which a reversible change is induced, such as solubility/insolubility, or hydrophilicity/hydrophobicity, due to a temperature change.

Among them, the temperature-responsive polymer is preferably a polymer whose solubility in water changes due to a temperature change and that is soluble in water at a low temperature, but becomes insoluble and cloudy/precipitated when the temperature is increased to a certain temperature (for example, lower critical solution temperature: LCST).

The temperature-responsive polymer can be obtained by adjusting the type and mixing ratio of the monomer to be used in the base polymer.

The base polymer contained in the pressure-sensitive adhesive composition according to the embodiment of the present invention contains structures derived from the water-insoluble hydrophilic monomer (a) and the nitrogen-containing hydrophilic monomer (b), and the content ratio of the structure derived from the water-insoluble hydrophilic monomer (a) in the base polymer is 40 mass % or more.

The base polymer may be a polymer containing structures derived from a water-insoluble hydrophilic monomer and a nitrogen-containing hydrophilic monomer, or may be a copolymer of another monomer component (c) other than these, the water-insoluble hydrophilic monomer (a), and the nitrogen-containing hydrophilic monomer (b). The base polymer may be a mixture of the polymer containing structures derived from the water-insoluble hydrophilic monomer (a) and the nitrogen-containing hydrophilic monomer (b) and a known polymer composed of another monomer (c).

When the base polymer contains the structures derived from the water-insoluble hydrophilic monomer (a) and the nitrogen-containing hydrophilic monomer (b), and the content ratio of the structure derived from the water-insoluble hydrophilic monomer (a) in the base polymer is 40 mass % or more, the water absorbency of the pressure-sensitive adhesive composition becomes good, and there is an effect of absorbing and removing remaining moisture, which inhibits adhesion, when the pressure-sensitive adhesive sheet is applied to an adherend in a wet state.

### Water-Insoluble Hydrophilic Monomer (a)

The water-insoluble hydrophilic monomer (a) refers to a monomer that is separated into an aqueous phase and an oil phase when the monomer and water are mixed. The water-insoluble hydrophilic monomer according to the present embodiment preferably has a hydrophilic group. Examples of the hydrophilic group include an alkoxy group such as a methoxy group and an ethoxy group, a hydroxy group, an amine group, and a carboxylic acid group.

In the base polymer according to the embodiment of the present invention, the content ratio of the structure derived from the water-insoluble hydrophilic monomer (a) needs to be 40 mass % or more, and the water-insoluble hydrophilic monomer (a) is preferably used as a primary monomer constituting the base polymer. When the base polymer contains the water-insoluble hydrophilic monomer (a) as the primary monomer, the base polymer has an effect of inhibiting swelling and solution in water.

The primary monomer is preferably a low Tg monomer. When the content of the low Tg monomer in the base polymer is large, a storage elastic modulus G′ tends to decrease and thus exhibit the pressure-sensitive adhesiveness. The low Tg monomer means a monomer having a low glass transition temperature (Tg) of a homopolymer. The low Tg monomer preferably has a Tg in the range of −70° C. to 0° C.

The water-insoluble hydrophilic monomer (a) according to the present embodiment is preferably a hydrophilic (meth)acrylate.

The hydrophilic (meth)acrylate according to the present embodiment is (meth)acrylate having a hydrophilic ester residue. One kind thereof may be used alone, or two or more kinds thereof may be contained. The hydrophilic (meth)acrylate is preferably at least one selected from the group consisting of alkoxyalkyl (meth)acrylate, polyalkylene glycol (meth)acrylate, hydroxyalkyl (meth)acrylate, and hydroxyaralkyl (meth)acrylate.

Specific examples thereof include alkoxyalkyl (meth)acrylates such as methoxyethyl acrylate (MEA) and ethoxyethoxyethyl acrylate (EEEA).

Examples of the polyalkylene glycol (meth)acrylate include methoxypolyethylene glycol (meth)acrylates or methoxypolypropylene glycol (meth)acrylates represented by a formula: CH₂═CR¹—CO—(O—CH₂CHR²)n-OR³ (in the formula, R¹ and R² each independently represent a hydrogen atom or a methyl group, R³ represents an alkyl group having 1 to 20 carbon atoms, and n represents an integer of 1 to 12).

The hydrophilic (meth)acrylate is preferably alkoxyalkyl (meth)acrylate having an alkoxy group having 1 to 4 carbon atoms, or methoxypolyethylene glycol (meth)acrylate.

More specifically, the hydrophilic (meth)acrylate is preferably at least one selected from methoxyethyl acrylate (MEA), ethoxy-diethylene glycol acrylate, methoxy-dipropylene glycol acrylate, or methoxy-triethylene glycol acrylate, and is more preferably methoxyethyl acrylate (MEA).

Among all monomer components constituting the base polymer, the water-insoluble hydrophilic monomer (a) is preferably used as the primary monomer. The content ratio of the water-insoluble hydrophilic monomer (a) needs to be 40 mass % or more, preferably 50 mass % or more, more preferably 70 mass % or more, and still more preferably 75 mass % or more, from the viewpoint of inhibiting swelling and solution in water. From the viewpoint of adhesiveness to a wet surface, the content ratio of the water-insoluble hydrophilic monomer (a) is preferably 99 mass % or less, more preferably 95 mass % or less, and still more preferably 90 mass % or less.

### Nitrogen-Containing Hydrophilic Monomer (b)

The nitrogen-containing hydrophilic monomer (b) according to the present embodiment refers to a monomer containing a nitrogen atom and a hydrophilic group. Examples of the hydrophilic group include a carboxylic acid group, a hydroxy group, and an amine group. The homopolymer of the nitrogen-containing hydrophilic monomer (b) is preferably water-soluble. The mass of the homopolymer powder after standing for one day in a 92% humidified environment at 40° C. is preferably increased by 5% or more.

The nitrogen-containing hydrophilic monomer (b) is soluble in water without being separated into an oil layer and an aqueous layer, and can be used as a water absorbing component in the base polymer according to the embodiment of the present invention. Here, the water absorbing component refers to a component capable of absorbing and retaining moisture. In the case where the base polymer contains the water absorbing component, the water absorbing component contained in the pressure-sensitive adhesive layer absorbs and retains moisture on the wet surface, which hinders the adhesion between a pressure-sensitive adhesive sheet 10 and an adherend, when the pressure-sensitive adhesive sheet 10 is attached to the wet surface of the adherend, whereby the initial adhesive force of the pressure-sensitive adhesive sheet 10 to the adherend is improved. Since moisture on the wet surface of the adherend is absorbed and removed by the water absorbing component, the initial adhesiveness to the wet surface is more easily improved.

The nitrogen-containing hydrophilic monomer (b) according to the present embodiment is preferably a water-soluble monomer. Examples thereof include nitrogen-containing water-soluble monomers such as (meth)acrylamide, dialkyl (meth)acrylamides such as N,N-dimethyl (meth)acrylamide, monoalkyl (meth)acrylamides such as N-isopropyl (meth)acrylamide, alkoxydiacetone acrylamide, hydroxyethyl acrylamide (HEAA), acryloyl morpholine (ACMO), N-vinyl-2-pyrrolidone (NVP), vinyl formamide (NVF), and N-vinyl acetamide (NVA). These may be used alone or in combination of two or more kinds thereof.

The nitrogen-containing hydrophilic monomer (b) is preferably at least one selected from N-vinyl-2-pyrrolidone, hydroxyethyl acrylamide, acryloyl morpholine, vinyl formamide, or vinyl acetamide.

The content ratio of the nitrogen-containing hydrophilic monomer (b) in all monomer components constituting the base polymer is preferably 1 mass % or more, more preferably 2.5 mass % or more, and still more preferably 5 mass % or more, from the viewpoint of adhesiveness to a wet surface. From the viewpoint of inhibiting swelling and solution in water, the content ratio of the nitrogen-containing hydrophilic monomer (b) is preferably 50 mass % or less, more preferably 40 mass % or less, and still more preferably 30 mass % or less.

### Another Monomer (c)

Another monomer (c) other than the water-insoluble hydrophilic monomer (a) and the nitrogen-containing hydrophilic monomer (b) is not particularly limited. A monomer corresponding to a known polymer used in the pressure-sensitive adhesive can be used.

When the base polymer contains another monomer (c), the effect of improving the cohesive force due to crosslinking of the polymer is obtained.

Examples of another monomer (c) include a hydroxyl group-containing monomer.

Examples of the hydroxyl group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate; polypropylene glycol mono (meth)acrylate; and N-hydroxyethyl (meth)acrylamide. Among them, preferred examples of the hydroxyl group-containing monomer include hydroxyalkyl (meth)acrylates having a linear alkyl group having 2 to 4 carbon atoms, and 2-hydroxyethyl acrylate (HEA) and 4-hydroxybutyl acrylate (4HBA) are preferred.

Examples of another monomer (c) further include a water-insoluble hydrophobic monomer. Examples of the water-insoluble hydrophobic monomer include (meth)acrylates such as alkyl (meth)acrylate (alkyl (meth)acrylate having a linear or branched alkyl group). Examples of the alkyl (meth)acrylate include alkyl (meth)acrylates having an alkyl group having 1 to 20 carbon atoms, such as methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. Among them, alkyl (meth)acrylates having an alkyl group having 1 to 14 carbon atoms are preferred, and alkyl (meth)acrylates having an alkyl group having 2 to 10 carbon atoms are more preferred. The term “(meth)acrylate” refers to an “acrylate” and/or a “methacrylate”, and the same applies to the others.

Examples of the (meth)acrylates other than the alkyl (meth)acrylates include (meth)acrylates having an alicyclic hydrocarbon group, such as cyclopentyl (meth)acrylate, cyclohexyl (meth)acrylate, and isobornyl (meth)acrylate, and (meth)acrylates having an aromatic hydrocarbon group, such as phenyl (meth)acrylate.

These (meth)acrylates can be used alone or in combination of two or more kinds thereof. As long as the monomer does not have a polar functional group, a monomer other than the acrylic monomer may be copolymerized with the (meth)acrylates.

In the present embodiment, a content of the alkyl (meth)acrylates in the (meth)acrylates is preferably 80 mass % or more, more preferably 90 mass % or more, and still more preferably 100 mass %.

The content ratio of another monomer (c) (preferably a hydroxyl group-containing monomer) in all monomer components constituting the base polymer is preferably 0.1 mass % or more, more preferably 1 mass % or more, and still more preferably 2 mass % or more, from the viewpoint of the number of crosslinking points of the polymer. From the viewpoint of preventing gelation of the pressure-sensitive adhesive, the content of another monomer (c) is preferably 50 mass % or less, more preferably 40 mass % or less, and still more preferably 30 mass % or less.

The content ratio of the water-insoluble hydrophobic monomer as another monomer (c) in all the monomer components constituting the base polymer is preferably 45 mass % or less, more preferably 40 mass % or less, and still more preferably 30 mass % or less, from the viewpoint of absorbing moisture on the wet surface.

### (Another Polymer)

The pressure-sensitive adhesive composition may contain a known polymer such as a modifier (hereinafter, also referred to as another polymer) in addition to the base polymer described above as long as the effects of the present invention are not significantly impaired. In this case, the content of the other polymer relative to the whole base polymer (100 mass %) is preferably 75 mass % or less, and more preferably 60 mass % or less.

### (Crosslinking Agent)

The pressure-sensitive adhesive composition according to the embodiment of the present invention preferably further contains a crosslinking agent. The introduction of a crosslinked structure into the base polymer allows the pressure-sensitive adhesive layer to have an appropriate cohesive force, thereby preventing adhesive residue at the time of peeling of the pressure-sensitive adhesive. For example, a crosslinking agent is added to a solution obtained after polymerization of the base polymer, and if necessary, irradiation with an actinic ray or heating is performed, whereby a crosslinked structure is introduced and crosslinking proceeds.

Examples of the crosslinking agent include a photocuring agent such as a photocurable monomer and a photocurable oligomer, an isocyanate-based crosslinking agent, an epoxy-based crosslinking agent, an oxazoline-based crosslinking agent, an aziridine-based crosslinking agent, a carbodiimide-based crosslinking agent, and a metal chelate-based crosslinking agent. These crosslinking agents react with functional groups such as a hydroxy group and a carboxy group introduced into the base polymer to form a crosslinked structure. The crosslinking agent is preferably a photocurable monomer, a photocurable oligomer, or an isocyanate-based crosslinking agent because the reactivity with a hydroxy group or a carboxy group of the base polymer is high and the crosslinked structure can be easily introduced. From the viewpoint of increasing the thickness of the pressure-sensitive adhesive layer, a photocuring agent is preferably used.

The crosslinking agent may be used alone or in combination of two or more kinds thereof.

As the photocuring agent, it is preferable to use a photocurable monomer or a photocurable oligomer. The photocuring agent is preferably a compound having two or more ethylenically unsaturated bonds in one molecule. The photocuring agent is preferably a compound having compatibility with the base polymer. In order to exhibit appropriate compatibility with the base polymer, the photocuring agent is preferably a liquid at room temperature. When the photocuring agent is compatible with the base polymer and uniformly dispersed in the composition, the contact area with the adherend can be secured. When the base polymer and the photocuring agent exhibit appropriate compatibility, a photo-crosslinked structure can be uniformly introduced into the pressure-sensitive adhesive layer.

When a photocurable pressure-sensitive adhesive composition containing a photocuring agent in addition to the base polymer is photocured, the cohesive force of the polymer is improved by forming a crosslinked structure of the pressure-sensitive adhesive, and thus the adhesive force to an adherend is improved.

In order to improve the cohesive force of the polymer, it is preferable to use a polyfunctional (meth)acrylate as the photocuring agent. Examples of the polyfunctional (meth)acrylate include polyethylene glycol di (meth)acrylate, polypropylene glycol di (meth)acrylate, polytetramethylene glycol di (meth)acrylate, bisphenol A ethylene oxide-modified di (meth)acrylate, bisphenol A propylene oxide-modified di (meth)acrylate, alkanediol di (meth)acrylate, tricyclodecanedimethanol di (meth)acrylate, ethoxylated isocyanuric acid tri (meth)acrylate, pentaerythritol tri (meth)acrylate, pentaerythritol di (meth)acrylate, trimethylolpropane tri (meth)acrylate, ditrimethylolpropane tetra (meth)acrylate, ethoxylated pentaerythritol tetra (meth)acrylate, pentaerythritol tetra (meth)acrylate, dipentaerythritol poly (meth)acrylate, dipentaerythritol hexa (meth)acrylate, neopentyl glycol di (meth)acrylate, glycerin di (meth)acrylate, urethane (meth)acrylate, epoxy (meth)acrylate, butadiene (meth)acrylate, and isoprene (meth)acrylate. Alkanediol di (meth)acrylate is preferred, and hexanediol diacrylate (HDDA) and trimethylolpropane tri (meth)acrylate (TMPTA) are more preferred.

When a photocurable compound is contained in the pressure-sensitive adhesive composition as an uncured monomer or oligomer, a photocurable pressure-sensitive adhesive layer is obtained. In order to provide the photocuring agent in an uncured state in the composition, it is preferable to add the photocuring agent to a polymer solution after polymerization of the base polymer.

The compatibility between the base polymer and the photocuring agent also depends on the molecular weight of the compound. The smaller the molecular weight of the photocurable compound is, the higher the compatibility with the base polymer tends to be. From the viewpoint of compatibility with the base polymer, the molecular weight of the photocuring agent is preferably 1500 or less, and more preferably 1000 or less.

The crosslinking agent in the present embodiment may be an isocyanate compound.

The isocyanate compound (isocyanate) is hydrolyzed in the presence of water to become an amine, and the isocyanate and the amine react with each other to form a urea bond, thereby performing curing. A chemical bond can be formed with a hydroxyl group, an amino group, a carboxyl group, or the like on the surface of the adherend.

Examples of the isocyanate compound include aliphatic isocyanates, alicyclic isocyanates, and aromatic isocyanates. Among these, aliphatic isocyanates and alicyclic isocyanates are preferred because the compatibility with a base polymer, particularly a rubber-based polymer is good, and the reactivity with moisture or water is slow.

Examples of the aliphatic isocyanates include ethylene diisocyanate, propylene diisocyanate, tetramethylene diisocyanate, hexamethylene diisocyanate (HDI), trimethylhexamethylene diisocyanate (TMHMDI), dodecamethylene diisocyanate, lysine diisocyanate (LDI), and lysine triisocyanate (LTI). Among them, hexamethylene diisocyanate is preferred.

Examples of the alicyclic isocyanates include isophorone diisocyanate (IPDI), cyclohexylene diisocyanate (CHDI), 4,4′-dicyclohexylmethane diisocyanate, hydrogenated XDI (H₆XDI), hydrogenated MDI (H₁₂MDI), and norbornene diisocyanate (NBDI).

Examples of the aromatic isocyanates include diphenylmethane diisocyanate (MDI) such as 4,4′-diphenylmethane diisocyanate, 2,4′-diphenylmethane diisocyanate, and 2,2′-diphenylmethane diisocyanate; crude diphenylmethane diisocyanate; polynuclear polymethylene polyphenylene polyisocyanate (polymeric MDI); tolylene diisocyanate (TDI) such as 2,4-toluene diisocyanate and 2,6-toluene diisocyanate; naphthalene diisocyanate (NDI) such as 1,4-naphthalene diisocyanate and 1,5-naphthalene diisocyanate; 1,5-tetrahydronaphthalene diisocyanate; phenylene diisocyanate (PDI) such as 1,2-phenylene diisocyanate, 1,3-phenylene diisocyanate, and 1,4-phenylene diisocyanate; xylene diisocyanate (XDI); tetramethylxylylene diisocyanate (TMXDI); tolidine diisocyanate (TODI); and 2,4,6-trimethylphenyl-1,3-diisocyanate, 2,4,6-triisopropylphenyl-1,3-diisocyanate, chlorophenylene-2,4-diisocyanate, 4,4′-diphenyl ether diisocyanate, 3,3′-dimethyl-4,4′-diphenylmethane diisocyanate, 3,3′-dimethoxy-4,4′-diphenylene diisocyanate, 3,3′-dichloro-4,4′-biphenylene diisocyanate and a trimethylolpropane adduct of tolylene diisocyanate.

The content of the crosslinking agent in the pressure-sensitive adhesive composition in the present embodiment is not particularly limited. From the viewpoint of obtaining a high adhesive force, the content of the crosslinking agent is preferably 0.005 parts by mass or more, more preferably 0.0075 parts by mass or more, and still more preferably 0.01 parts by mass or more, relative to 100 parts by mass of the monomer constituting the base polymer. The content of the crosslinking agent is preferably 1 part by mass or less, more preferably 0.5 parts by mass or less, and still more preferably 0.1 parts by mass or less, from the viewpoint of inhibiting an increase in storage elastic modulus due to crosslinking.

The preferred range of the content of the crosslinking agent relative to 100 parts by mass of the base polymer in the pressure-sensitive adhesive layer is substantially the same as the preferred range of the content of the crosslinking agent relative to 100 parts by mass of the monomer constituting the base polymer in the pressure-sensitive adhesive composition, and the same applies to other components that can be contained in the pressure-sensitive adhesive composition (pressure-sensitive adhesive layer).

The pressure-sensitive adhesive composition according to the present embodiment may contain a tackifier for the purpose of adjusting the elastic modulus and imparting tack at the time of initial adhesion. Examples of the tackifier include polybutenes, rosin-based resins, terpene-based resins, petroleum-based resins (for example, petroleum-based aliphatic hydrocarbon resins, petroleum-based aromatic hydrocarbon resins, petroleum-based aliphatic/aromatic copolymerized hydrocarbon resins, petroleum-based alicyclic hydrocarbon resins (hydrogenated aromatic hydrocarbon resins)), and coumarone-based resins. From the viewpoint of compatibility with the base polymer, petroleum-based resins or rosin-based resins are preferred. The tackifiers may be used alone or in combination of two or more kinds thereof.

When the tackifier is contained in the pressure-sensitive adhesive composition, the content thereof is preferably 10 parts by mass or more, more preferably 30 parts by mass or more, and still more preferably 50 parts by mass or more, relative to 100 parts by mass of the base polymer, from the viewpoint of reducing the elastic modulus. The content of the tackifier is preferably 500 parts by mass or less, more preferably 400 parts by mass or less, and still more preferably 250 parts by mass or less, relative to 100 parts by mass of the base polymer, from the viewpoint of imparting an appropriate cohesive force to the pressure-sensitive adhesive.

The pressure-sensitive adhesive composition of the present embodiment may further contain additives usually added to the pressure-sensitive adhesive composition, such as a polymerization initiator, a viscosity modifier, a release modifier, a plasticizer, a softener, a filler, a colorant (a pigment, a dye, or the like), an anti-aging agent, a surfactant, a leveling agent, an antifoaming agent, and a light stabilizer, as long as the effects of the present invention are not impaired.

Examples of the polymerization initiator include azos, benzoin ethers, benzyl ketals, acetophenones, alkylphenones, monoacylphosphine oxides, and monoacylphosphine oxides such as bis(2,6-dimethoxybenzoyl)-2,4,4-trimethylpentylphosphine oxide and bis(2,4,6-trimethylbenzoyl)phenylphosphine oxide. Alkylphenone-based photopolymerization initiators are preferred, and 1-hydroxycyclohexyl phenyl ketone, 2-hydroxy-2-methyl-1-phenyl-propan-1-one, (2-hydroxy-1-{4-[4-(2-hydroxy-2-methyl-propionyl)benzyl]phenyl}-2-methyl-propan-1-one, and 1-[4-(2-hydroxyethoxy)-phenyl]-2-hydroxy-2-methyl-1-propan-1-one are more preferred. Examples of commercially available products include Irgacure 127, 184, 369, 651, 500, 891, 907, 2959, Darocure 1173, and TPO (trade name, manufactured by BASF Japan Ltd.). The polymerization initiators may be used alone or in combination of two or more kinds thereof.

The content of the polymerization initiator is preferably 0.01 parts by mass or more, more preferably 0.025 parts by mass or more, and still more preferably 0.05 parts by mass or more, relative to 100 parts by mass of the monomer contained in the pressure-sensitive adhesive composition. From the viewpoint of the molecular weight of the polymer to be obtained, the content of the polymerization initiator is preferably 1 part by mass or less, more preferably 0.5 parts by mass or less, and still more preferably 0.25 parts by mass or less.

Examples of the filler include inorganic fillers such as talc, titanium oxide, calcium oxide, magnesium oxide, zinc oxide, titanium oxide, calcium carbonate, carbon, silica, clay, mica, barium sulfate, whisker, and magnesium hydroxide.

The content of the filler is preferably 500 parts by mass or less, more preferably 300 parts by mass or less, relative to 100 parts by mass of the base polymer, from the viewpoint of rough surface adhesiveness.

As the solvent used for the pressure-sensitive adhesive composition, various general solvents can be used. Examples of the solvent include organic solvents, for example, esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methyl ethyl ketone and methyl isobutyl ketone. The solvent may be used alone or in combination of two or more kinds thereof.

As for the pressure-sensitive adhesive composition according to the present embodiment, when the pressure-sensitive adhesive layer is formed, the Young's modulus of the pressure-sensitive adhesive layer at 25° C. is preferably 0.1 kPa or more, more preferably 1 kPa or more, still more preferably 5 kPa or more, and particularly preferably 10 kPa or more. When the Young's modulus is 0.1 kPa or more, deformation of the pressure-sensitive adhesive layer is less likely to occur, and the shape stability of the pressure-sensitive adhesive sheet is good. In addition, problems such as adhesive extrusion are less likely to occur due to stress applied after adhesion.

From the viewpoint of adhesion to the wet surface, the Young's modulus is preferably 400 kPa or less, more preferably 200 kPa or less, and still more preferably 100 kPa or less. When the Young's modulus is 400 kPa or less, good adhesive force can be exhibited even in a wet adherend, and excellent water resistance can be exhibited.

Here, the Young's modulus of the pressure-sensitive adhesive layer when the pressure-sensitive adhesive layer is formed can be calculated from a stress-strain curve measured when a sample in which the pressure-sensitive adhesive layer is formed in a string shape is prepared, and then pulled at a rate of 50 mm/min using a tensile tester (AG-IS manufactured by Shimadzu Corporation).

### [Pressure-Sensitive Adhesive Layer]

The pressure-sensitive adhesive layer of the present embodiment is formed using the above pressure-sensitive adhesive composition.

The pressure-sensitive adhesive layer according to the embodiment of the present invention preferably has a water absorption amount of 9.0 mg or more as measured by the following method.

Measurement method of water absorption amount: the pressure-sensitive adhesive layer having a thickness of 100 μm is attached to a PET film having a thickness of 50 μm and cut into a size of 2.5 cm×5 cm to obtain a measurement sample, and the water absorption amount is calculated from a difference between a mass of the measurement sample after immersion in pure water under the following conditions and a mass of the measurement sample before immersion.

Immersion temperature: 23° C.

Immersion time: 5 minutes

By setting the water absorption amount of the pressure-sensitive adhesive layer according to the embodiment of the present invention to 9.0 mg or more, the pressure-sensitive adhesive layer absorbs and retains moisture on the wet surface, which hinders adhesion between the pressure-sensitive adhesive sheet 10 and the adherend, when the pressure-sensitive adhesive sheet 10 is attached to the wet surface of the adherend, whereby the initial adhesive force of the pressure-sensitive adhesive sheet 10 to the adherend is improved. In addition, since moisture on the wet surface of the adherend is absorbed and removed, the initial adhesiveness to the wet surface is more easily improved.

The pressure-sensitive adhesive layer according to the present embodiment has the water absorption amount of preferably 9.0 mg or more, preferably 15 mg or more, more preferably 17.5 mg or more, and still more preferably 20 mg or more. From the viewpoint of swelling during immersion in water, the pressure-sensitive adhesive layer according to the present embodiment has the water absorption amount of preferably 50 mg or less, more preferably 45 mg or less, and still more preferably 40 mg or less.

The pressure-sensitive adhesive layer according to the embodiment of the present invention preferably has temperature responsiveness. Specifically, the swelling degree of the pressure-sensitive adhesive layer after immersion in water at 5° C. for 24 hours is preferably 2.5 or more, more preferably 3 or more, and still more preferably 5 or more. In addition, the swelling degree is preferably 10 or less, more preferably 9 or less, and still more preferably 7.5 or less.

The swelling degree of the pressure-sensitive adhesive layer after immersion in water at 23° C. for 24 hours is preferably 1.0 or more, more preferably 1.1 or more, and still more preferably 1.5 or more. In addition, the swelling degree is preferably 2.5 or less, more preferably 2.25 or less, and still more preferably 2 or less.

The swelling degree of the pressure-sensitive adhesive layer after immersion in water at 5° C. for 24 hours is preferably 2.5 to 10. The swelling degree of the pressure-sensitive adhesive layer after immersion in water at 23° C. for 24 hours is preferably 1.0 to 2.5.

The swelling degree can be calculated by the following formula.

Swelling degree=(Mass after immersion for 24 hours/initial mass)×100

By using a temperature-responsive polymer as the base polymer used in the pressure-sensitive adhesive composition according to the present embodiment, the pressure-sensitive adhesive layer according to the embodiment of the present invention can be provided with temperature responsiveness.

The pressure-sensitive adhesive layer in the present embodiment is formed using the above pressure-sensitive adhesive composition. The formation method is not particularly limited, and a known method can be employed. For example, the pressure-sensitive adhesive composition is applied to a substrate to be described later using a known coating method and is dried, so that a pressure-sensitive adhesive layer can be obtained in the form of a pressure-sensitive adhesive sheet.

The preferred range of the amount of each component in the pressure-sensitive adhesive layer is the same as the preferred range of the amount of each component excluding the solvent in the pressure-sensitive adhesive composition.

In addition, as for the pressure-sensitive adhesive layer, the pressure-sensitive adhesive composition may be applied to a release liner (may be a sheet-shaped substrate having a release surface) to form a pressure-sensitive adhesive layer. The pressure-sensitive adhesive composition may be applied to a releasable surface and dried or cured to form a pressure-sensitive adhesive layer on the surface, and then the pressure-sensitive adhesive layer may be bonded to a non-releasable substrate and transferred thereto.

The method for applying the pressure-sensitive adhesive composition to the substrate is not particularly limited, and the pressure-sensitive adhesive composition can be applied using, for example, a gravure roll coater, a reverse roll coater, a kiss roll coater, a dip roll coater, a bar coater, a knife coater, a spray coater, a fountain die coater, a closed edge die coater, or the like.

The pressure-sensitive adhesive layer is formed by applying the pressure-sensitive adhesive composition to a substrate and drying and removing the solvent as necessary. As the drying method, an appropriate method can be appropriately adopted.

The drying temperature may be, for example, 50° C. to 150° C. The drying time is preferably 5 seconds to 20 minutes, more preferably 5 seconds to 15 minutes, and still more preferably 10 seconds to 10 minutes.

When the pressure-sensitive adhesive composition contains a crosslinking agent, it is preferable to cure the pressure-sensitive adhesive layer by promoting crosslinking by irradiation with an actinic ray, heating, or aging simultaneously with or after drying of the solvent.

Examples of the actinic ray include ultraviolet rays, visible light, infrared rays, X-rays, α-rays, β-rays, and γ-rays. Ultraviolet rays are preferred as the actinic ray because curing of the pressure-sensitive adhesive layer in a storage state can be inhibited and curing is easy. The irradiation intensity and the irradiation time of the actinic ray may be appropriately set depending on the composition, thickness, and the like of the pressure-sensitive adhesive layer.

The heating temperature and the heating time are appropriately set depending on the type of the crosslinking agent to be used, and crosslinking is usually performed by heating in the range of 20° C. to 160° C. for about 1 minute to 7 days. The heating for drying and removing the solvent may also serve as heating for crosslinking.

The thickness of the pressure-sensitive adhesive layer after drying is not particularly limited, but is preferably 5 μm to 5000 μm, and more preferably 10 μm to 1000 μm, from the viewpoint of exhibiting good adhesive force to an adherend.

The pressure-sensitive adhesive layer is typically formed continuously, but is not limited to such a form, and may be, for example, a layer formed in a regular or random pattern such as a dot pattern or a stripe pattern.

The pressure-sensitive adhesive layer may be formed by a solvent-free coating method such as rolling or extrusion. In this case, the pressure-sensitive adhesive composition can be obtained as a kneaded product by performing heating and kneading. For the kneading, for example, a batch type kneader such as a kneader, a Banbury mixer, and a mixing roll, or a continuous kneader such as a biaxial kneader is used. The heating temperature in the kneading may be, for example, 80° C. to 180° C.

The pressure-sensitive adhesive composition obtained as described above can be heated by a molding apparatus such as an extruder, a calender roll, or a press machine (heat press machine) to form the pressure-sensitive adhesive layer into a sheet shape.

### [Pressure-Sensitive Adhesive Sheet]

A pressure-sensitive adhesive sheet according to the embodiment of the present invention includes the pressure-sensitive adhesive layer according to the embodiment of the present invention.

The pressure-sensitive adhesive layer according to the embodiment of the present invention is formed of the pressure-sensitive adhesive composition according to the embodiment of the present invention.

In the pressure-sensitive adhesive sheet according to the embodiment of the present invention, the pressure-sensitive adhesive layer is preferably formed on a substrate.

Here, in the present specification, the term “pressure-sensitive adhesive sheet” may include those referred to as “pressure-sensitive adhesive tape”, “pressure-sensitive adhesive label”, “pressure-sensitive adhesive film”, and the like. The pressure-sensitive adhesive sheet may be a substrate-less pressure-sensitive adhesive sheet including the pressure-sensitive adhesive layer held on a release liner.

The pressure-sensitive adhesive sheet of the present embodiment may include another pressure-sensitive adhesive layer having a composition different from that of the above pressure-sensitive adhesive layer.

The term “pressure-sensitive adhesive surface” refers to a surface (attachment surface) of the pressure-sensitive adhesive sheet on a side to be attached to an adherend. In the pressure-sensitive adhesive sheet of the present invention, only one surface may be a pressure-sensitive adhesive surface, or both surfaces may be pressure-sensitive adhesive surfaces.

The term “unreacted state” refers to a state in which a curing reaction does not occur due to water, a compound having active hydrogen, or the like. Alternatively, the term “unreacted state” refers to a state in which a functional group capable of chemically bonding with an adherend remains. In the pressure-sensitive adhesive sheet of the present invention, only one surface may be a pressure-sensitive adhesive surface, or both surfaces may be pressure-sensitive adhesive surfaces.

In the present specification, “(meth)acryl” means acryl or methacryl, and similarly, “(meth)acrylate” means acrylate or methacrylate.

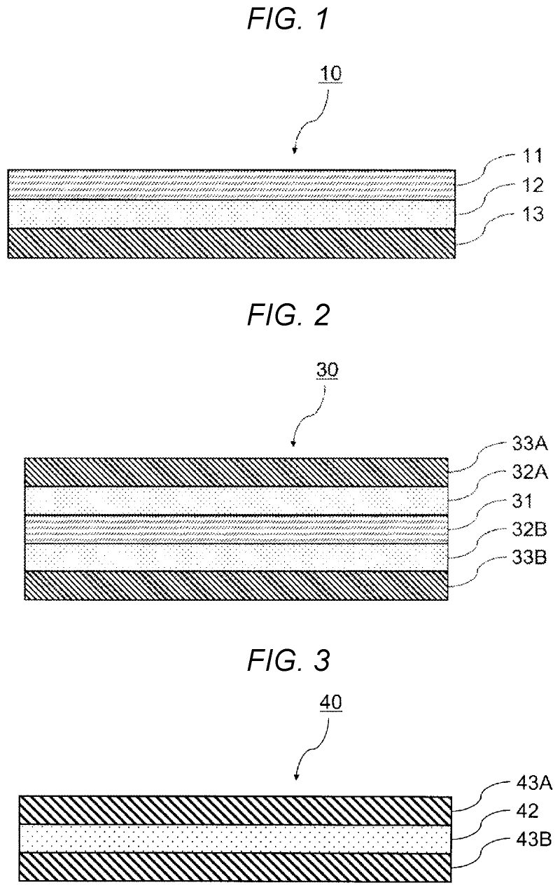

FIG. 1 is an example of a schematic cross-sectional view of a pressure-sensitive adhesive sheet according to an embodiment of the present invention.

The pressure-sensitive adhesive sheet 10 of the present embodiment may include a substrate 11 and a pressure-sensitive adhesive layer 12, and a surface of the pressure-sensitive adhesive layer 12 on a side opposite to a side to which the substrate 11 is set may be releasably covered with a release liner 13.

The pressure-sensitive adhesive sheet 10 of the present embodiment is used by peeling and removing the release liner 13 and attaching the pressure-sensitive adhesive sheet 10 to an adherend via the pressure-sensitive adhesive layer 12. That is, a surface of the pressure-sensitive adhesive layer 12 on a side to which the release liner 13 is set is the pressure-sensitive adhesive surface in the present embodiment.

As shown in FIG. 2, a pressure-sensitive adhesive sheet according to an embodiment of the present invention may include a pressure-sensitive adhesive layer on both sides of a substrate, and the pressure-sensitive adhesive layer may be protected by a release liner.

The pressure-sensitive adhesive sheet 30 of the present embodiment may include a first release liner 33A, a first pressure-sensitive adhesive layer 32A, a substrate 31, a second pressure-sensitive adhesive layer 32B, and a second release liner 33B in this order.

The pressure-sensitive adhesive sheet 30 of the present embodiment is used by peeling and removing the first release liner 33A and the second release liner 33B, and attaching the first pressure-sensitive adhesive layer 32A and the second pressure-sensitive adhesive layer 32B to different adherends. That is, in the present embodiment, both a surface of the first pressure-sensitive adhesive layer 32A on a side to which the first release liner 33A is set and a surface of the second pressure-sensitive adhesive layer 32B on a side to which the second release liner 33B is set are pressure-sensitive adhesive surfaces.

The substrate 31, the first and second pressure-sensitive adhesive layers 32A and 32B, and the first and second release liners 33A and 33B in the present embodiment are the same as the substrate 11, the pressure-sensitive adhesive layer 12, and the release liner 13 described above.

The pressure-sensitive adhesive sheet 30 in the present embodiment may be wound. That is, the pressure-sensitive adhesive sheet 30 of the present embodiment, for example, may not include the second release liner 33B, and may be wound such that the pressure-sensitive adhesive surface of the second pressure-sensitive adhesive layer 32B is attached to a surface of the first release liner 33A on a side opposite to a side to which the first pressure-sensitive adhesive layer 32A is set.

As shown in FIG. 3, a pressure-sensitive adhesive sheet according to an embodiment of the present invention may not include a substrate, and both surfaces of the pressure-sensitive adhesive layer may be protected by release liners.

That is, a pressure-sensitive adhesive sheet 40 of the present embodiment may include a first release liner 43A, a pressure-sensitive adhesive layer 42, and a second release liner 43B in this order.

The pressure-sensitive adhesive sheet 40 of the present embodiment is used by peeling and removing the first release liner 43A and the second release liner 43B, and attaching one surface and the other surface of the pressure-sensitive adhesive layer 42 to different adherends. That is, in the present embodiment, both the surface of the pressure-sensitive adhesive layer 42 on a side to which the first release liner 43A is set and the surface of the pressure-sensitive adhesive layer 42 on a side to which the second release liner 43B is set are pressure-sensitive adhesive surfaces.

The pressure-sensitive adhesive sheet according to the embodiment of the present invention may be a pressure-sensitive adhesive sheet in which the pressure-sensitive adhesive force of the pressure-sensitive adhesive layer is reduced by irradiation with an active energy ray. In the case where the pressure-sensitive adhesive sheet according to the embodiment of the present invention is used for protecting a member in a manufacturing process of an electronic component or an electronic device or the like, the pressure-sensitive adhesive force of the pressure-sensitive adhesive layer is reduced by irradiation with an active energy ray, whereby a reduction in yield due to deformation, breakage, or the like of the member at the time of peeling can be inhibited.

Examples of the active energy ray include light rays such as far ultraviolet rays, ultraviolet rays, near ultraviolet rays, and infrared rays; electromagnetic waves such as X-rays and γ-rays; electron beams; proton beams; and neutron beams. In the embodiment of the present invention, ultraviolet rays are preferred in that the effects of the present invention can be further expressed.

When the pressure-sensitive adhesive sheet according to the embodiment of the present invention is irradiated with an active energy ray, any appropriate irradiation direction can be adopted as the irradiation direction as long as the effects of the present invention are not impaired. As for such an irradiation direction, an incident angle relative to the sheet surface of the pressure-sensitive adhesive sheet according to the embodiment of the present invention is preferably more than 0° and 900 or less, more preferably 30° to 90°, still more preferably 450 to 90°, and particularly preferably 60° to 90°.

The 180° release force of the pressure-sensitive adhesive sheet according to the embodiment of the present invention relative to a SUS plate after ultraviolet irradiation is preferably 0.5 N/20 mm or less, more preferably 0.3 N/20 mm or less, still more preferably 0.22 N/20 mm or less. The lower limit of the release force of the pressure-sensitive adhesive sheet according to the embodiment of the present invention after ultraviolet irradiation may be any appropriate lower limit as long as the effects of the present invention are not impaired. The lower limit of the release force of the pressure-sensitive adhesive sheet of the present invention after ultraviolet irradiation is, for example, 0.01 N/20 mm or more. When the release force of the pressure-sensitive adhesive sheet according to the embodiment of the present invention after ultraviolet irradiation is 0.5 N/20 mm or less, the pressure-sensitive adhesive sheet can express excellent light releasability by ultraviolet irradiation. When the release force of the pressure-sensitive adhesive sheet according to the embodiment of the present invention after ultraviolet irradiation is more than 0.5 N/20 mm, the pressure-sensitive adhesive sheet may be inferior in light releasability even when the pressure-sensitive adhesive sheet is irradiated with ultraviolet rays.

The pressure-sensitive adhesive force after ultraviolet irradiation is measured in accordance with JIS Z0237: 2009. After the pressure-sensitive adhesive sheet is attached to the test plate and then allowed to stand for 30 minutes, the pressure-sensitive adhesive sheet is irradiated with ultraviolet rays (high-pressure mercury lamp, 500 mJ/cm²) for 1 minute, and the peeling pressure-sensitive adhesive force (release force) is measured. The test plate is a SUS plate, and toluene is used as a cleaning solvent for the test plate. More details will be described later in the section of Examples.

### (Substrate)

Examples of the material for forming the substrate include polyolefin-based films such as polyethylene, polypropylene, and ethylene-propylene copolymers; polyester-based films such as polyethylene terephthalate; plastic films such as polyvinyl chloride; paper such as kraft paper and Japanese paper; fabrics such as cotton cloth and staple cloth; fabric woven fabrics such as a polyester nonwoven fabric and a vinylon fabric woven fabric; and metal foils. The thickness of the substrate is not particularly limited.

The plastic films may be unstretched films or stretched (uniaxially stretched or biaxially stretched) films. The surface of the substrate on which the pressure-sensitive adhesive layer is to be provided may be subjected to a surface treatment such as coating of an undercoat agent or a corona discharging treatment.

In the present embodiment, the pressure-sensitive adhesive sheet may be perforated to provide a through hole. In this case, when the pressure-sensitive adhesive sheet is attached to the adherend, moisture on the wet surface of the adherend can be released to the back surface side of the pressure-sensitive adhesive sheet (the side opposite to the attachment surface) through the through hole, so that more moisture on the wet surface of the adherend can be removed.

### (Release Liner)

In the pressure-sensitive adhesive sheet of the present embodiment, the pressure-sensitive adhesive layer and the other pressure-sensitive adhesive layer according to the embodiment of the present invention may be protected by a release liner (separator, release film) until they are used.

As the release liner, a common release paper or the like can be used and is not particularly limited, and for example, a substrate including a release treatment layer, a low adhesive substrate formed of a fluorine-based polymer, and a low adhesive substrate formed of a nonpolar polymer can be used.

Examples of the substrate including a release treatment layer include a plastic film or paper surface-treated with a release treatment agent such as a silicone-based release treatment agent, a long-chain alkyl-based release treatment agent, a fluorine-based release treatment agent, and molybdenum sulfide.

Examples of the fluorine-based polymer of the low adhesive substrate formed of a fluorine-based polymer include polytetrafluoroethylene, polychlorotrifluoroethylene, polyvinyl fluoride, polyvinylidene fluoride, a tetrafluoroethylene-hexafluoropropylene copolymer, and a chlorofluoroethylene-vinylidene fluoride copolymer.

Examples of the nonpolar polymer of the low adhesive substrate formed of a nonpolar polymer include olefin-based resins (for example, polyethylene, and polypropylene). The release liner can be formed by a known or common method. The thickness and the like of the release liner are also not particularly limited.

### (Adherend)

Examples of the adherend include concrete, mortar, asphalt, metals (for example, SUS plates, and Al plates), wood, tiles, plastic materials (for example, acrylic plates, and baked plates), building exterior materials and interior materials such as a coated film surface and an inner wall of a bathroom, underwater and water surface structures such as ships and buoys, water tanks, bathtubs, sports tools, fabrics such as woven fabrics and nonwoven fabrics, porous bodies such as paper, electrolyte membranes, separation membranes, and filters, and printed wiring boards. In addition, the adherend may be a living organism, and may be an outside of the living organism (for example, a skin, an outer shell, and a scale), or an inside of the living organism (for example, a tooth, and a bone).

### EXAMPLES

Hereinafter, the present invention will be specifically described with reference to Examples, but the present invention is not limited to these Examples.

### Example 1

### (Preparation of Pressure-Sensitive Adhesive Composition)

To a mixture composed of 90 parts by mass of methoxyethyl acrylate (MEA) (Acryx C-1, manufactured by Toagosei Co., Ltd.) as a water-insoluble hydrophilic monomer, 5 parts by mass of N-vinyl-2-pyrrolidone (NVP, manufactured by Tokyo Chemical Industry Co., Ltd.) as a water-soluble hydrophilic monomer, and 5 parts by mass of 4-hydroxybutyl acrylate (4HBA) (4-HBA, manufactured by Osaka Organic Industry Co., Ltd.) as a hydroxyl group-containing monomer, 0.1 parts by mass of 1-hydroxycyclohexyl phenyl ketone (“Irgacure 184”, manufactured by BASF) and 0.1 parts by mass of 2,2-dimethoxy-1,2-diphenylethan-1-one (“Irgacure 651”, manufactured by BASF) as photopolymerization initiators were added. After nitrogen substitution was performed for 30 minutes under the condition of 0.3 L/min, the composition was irradiated with ultraviolet rays, and pre-polymerization was performed until the viscosity at room temperature (25° C.) became about 20 Pa·s, thereby obtaining a prepolymer 1 having a polymerization rate of about 8%.

Next, 0.02 parts by mass of hexanediol diacrylate (HDDA, Biscoat #230 manufactured by Osaka Organic Chemical Industry Ltd.) as a crosslinking agent and 0.1 parts by mass of 1-hydroxycyclohexyl phenyl ketone (“Irgacure 184” manufactured by BASF) as a photopolymerization initiator were added to the prepolymer 1, followed by stirring. This mixed solution was applied to a PET film release liner (trade name “Diafoil MRF”, manufactured by Mitsubishi Chemical Corporation, thickness: 38 μm) to a thickness of 100 μm to form a coating layer, and a release liner (trade name “Diafoil MRE”, manufactured by Mitsubishi Chemical Corporation, thickness: 38 μm) of a PET film as a cover release film was bonded to the surface of the coating layer to obtain a laminate. The laminate was irradiated with ultraviolet rays under the conditions of an illuminance of 6.5 mW/cm² and an integrated light amount of 3000 mJ/cm² to photo-cure the coating layer to form a pressure-sensitive adhesive layer, thereby producing a pressure-sensitive adhesive sheet having release films on both surfaces. Thereafter, the cover release film was peeled off, and a PET film (Diafoil T100-50 manufactured by Mitsubishi Plastics, Inc.) having a thickness of 50 μm was bonded to prepare a pressure-sensitive adhesive sheet.

### Example 2

A pressure-sensitive adhesive sheet of Example 2 was prepared in the same manner as in Example 1, except that monomers used were changed to 85 parts by mass of methoxyethyl acrylate (Acryx C-1 manufactured by Toagosei Co., Ltd.) as a water-insoluble hydrophilic monomer and 10 parts by mass of N-vinyl-2-pyrrolidone (manufactured by Tokyo Chemical Industry Co., Ltd.) as a water-soluble hydrophilic monomer.

### Example 3

A pressure-sensitive adhesive sheet of Example 3 was prepared in the same manner as in Example 1, except that monomers used were changed to 80 parts by mass of methoxyethyl acrylate (Acryx C-1 manufactured by Toagosei Co., Ltd.) as a water-insoluble hydrophilic monomer and 15 parts by mass of N-vinyl-2-pyrrolidone (manufactured by Tokyo Chemical Industry Co., Ltd.) as a water-soluble hydrophilic monomer.

### Example 4

A pressure-sensitive adhesive sheet of Example 4 was prepared in the same manner as in Example 1, except that monomers used were changed to 70 parts by mass of methoxyethyl acrylate (Acryx C-1 manufactured by Toagosei Co., Ltd.) as a water-insoluble hydrophilic monomer and 25 parts by mass of N-vinyl-2-pyrrolidone (manufactured by Tokyo Chemical Industry Co., Ltd.) as a water-soluble hydrophilic monomer.

### Example 5

A pressure-sensitive adhesive sheet of Example 5 was prepared in the same manner as in Example 1 except that monomers used were changed to 50 parts by mass of methoxyethyl acrylate (Acryx C-1 manufactured by Toagosei Co., Ltd.) as a water-insoluble hydrophilic monomer and 45 parts by mass of N-vinyl-2-pyrrolidone (manufactured by Tokyo Chemical Industry Co., Ltd.) as a water-soluble hydrophilic monomer.

### Example 6

To a four-necked flask equipped with a stirring blade, a thermometer, a nitrogen gas inlet tube, and a cooler, 85 parts by mass of methoxyethyl acrylate (Acryx C-1, manufactured by Toagosei Co., Ltd.) as a water-insoluble hydrophilic monomer, 10 parts by mass of N-vinyl-2-pyrrolidone (manufactured by Tokyo Chemical Industry Co., Ltd.) as a water-soluble hydrophilic monomer, 5 parts by mass of 4-hydroxybutyl acrylate (4-HBA, manufactured by Osaka Organic Industry Co., Ltd.) as a hydroxyl group-containing monomer, 0.2 parts by mass of 2,2′-azobisisobutyronitrile as a polymerization initiator, and 300 parts by mass of ethyl acetate were placed, nitrogen gas was introduced while gently stirring, and a polymerization reaction was performed for 7 hours while maintaining the liquid temperature in the flask at around 60° C. to prepare an ethyl acetate solution 1 of an acrylic polymer (solid content concentration: 25%).

Next, 0.5 parts by mass of a trimethylolpropane adduct of tolylene diisocyanate (Coronate L manufactured by Tosoh Corporation) as a crosslinking agent was added to the ethyl acetate solution 1 of the acrylic polymer, followed by stirring. This mixed solution was applied to a PET film release liner (trade name, “Diafoil MRF”, manufactured by Mitsubishi Chemical Corporation, thickness: 38 μm), and dried by heating at 130° C. for 10 minutes to form a coating layer having a thickness of 100 μm. Thereafter, a PET film release liner (trade name “Diafoil MRE” manufactured by Mitsubishi Chemical Corporation, thickness: 38 μm) as a cover release film was attached to the surface of the coating layer, and subjected to a heat treatment at 50° C. for 48 hours to form a pressure-sensitive adhesive layer, thereby preparing a pressure-sensitive adhesive sheet of Example 6.

### Example 7

A pressure-sensitive adhesive sheet of Example 7 was prepared in the same manner as in Example 1, except that monomers used were changed to 90 parts by mass of methoxyethyl acrylate (Aclex C-1 manufactured by Toagosei Co., Ltd.) as a water-insoluble hydrophilic monomer and 5 parts by mass of acryloyl morpholine (ACMO manufactured by KJ Chemicals Co., Ltd.) as a water-soluble hydrophilic monomer.

### Example 8

A pressure-sensitive adhesive sheet of Example 8 was prepared in the same manner as in Example 1, except that monomers used were changed to 70 parts by mass of methoxyethyl acrylate (Aclex C-1 manufactured by Toagosei Co., Ltd.) as a water-insoluble hydrophilic monomer and 25 parts by mass of acryloyl morpholine (ACMO manufactured by KJ Chemicals Co., Ltd.) as a water-soluble hydrophilic monomer.

### Example 9

A pressure-sensitive adhesive sheet of Example 9 was prepared in the same manner as in Example 1, except that monomers used were changed to 90 parts by mass of methoxyethyl acrylate (Acryx C-1 manufactured by Toagosei Co., Ltd.) as a water-insoluble hydrophilic monomer and 5 parts by mass of hydroxyethyl acrylamide (HEAA manufactured by KJ Chemicals Corporation) as a water-soluble hydrophilic monomer.

### Example 10

A pressure-sensitive adhesive sheet of Example 10 was prepared in the same manner as in Example 1, except that monomers used were changed to 70 parts by mass of methoxyethyl acrylate (Acryx C-1 manufactured by Toagosei Co., Ltd.) as a water-insoluble hydrophilic monomer and 25 parts by mass of hydroxyethyl acrylamide (HEAA manufactured by KJ Chemicals Corporation) as a water-soluble hydrophilic monomer.

### Example 11

A pressure-sensitive adhesive sheet of Example 11 was prepared in the same manner as in Example 1, except that monomers used were changed to 85 parts by mass of ethoxy-diethylene glycol acrylate (Light Acrylate EC-A manufactured by Kyoeisha Chemical Co., Ltd.) as a water-insoluble hydrophilic monomer and 10 parts by mass of N-vinyl-2-pyrrolidone (manufactured by Tokyo Chemical Industry Co., Ltd.) as a water-soluble hydrophilic monomer.

### Example 12

A pressure-sensitive adhesive sheet of Example 12 was prepared in the same manner as in Example 1, except that monomers used were changed to 85 parts by mass of methoxy-dipropylene glycol acrylate (Light Acrylate DPM-A manufactured by Kyoeisha Chemical Co., Ltd.) as a water-insoluble hydrophilic monomer and 10 parts by mass of N-vinyl-2-pyrrolidone (manufactured by Tokyo Chemical Industry Co., Ltd.) as a water-soluble hydrophilic monomer.

### Example 13

A pressure-sensitive adhesive sheet of Example 13 was prepared in the same manner as in Example 1, except that monomers used were changed to 85 parts by mass of methoxy-triethylene glycol acrylate (Light Acrylate MTG-A manufactured by Kyoeisha Chemical Co., Ltd.) as a water-insoluble hydrophilic monomer and 10 parts by mass of N-vinyl-2-pyrrolidone (manufactured by Tokyo Chemical Industry Co., Ltd.) as a water-soluble hydrophilic monomer.

### Example 14

A pressure-sensitive adhesive sheet of Example 14 was prepared in the same manner as in Example 1, except that monomers used were changed to 85 parts by mass of methoxyethyl acrylate (Acryx C-1 manufactured by Toagosei Co., Ltd.) as a water-insoluble hydrophilic monomer and 10 parts by mass of N-vinylformamide (manufactured by Tokyo Chemical Industry Co., Ltd.)) as a water-soluble hydrophilic monomer.

### Example 15

A pressure-sensitive adhesive sheet of Example 15 was prepared in the same manner as in Example 1, except that monomers used were changed to 85 parts by mass of methoxyethyl acrylate (Acryx C-1 manufactured by Toagosei Co., Ltd.) as a water-insoluble hydrophilic monomer and 10 parts by mass of N-vinylacetamide (manufactured by Tokyo Chemical Industry Co., Ltd.) as a water-soluble hydrophilic monomer.

### Example 16

A pressure-sensitive adhesive sheet of Example 16 was prepared in the same manner as in Example 1, except that monomers used were changed to 21.25 parts by mass of 2-ethylhexyl acrylate (2EHA manufactured by Mitsubishi Chemical Corporation) as a water-insoluble hydrophobic monomer, 63.75 parts by mass of methoxyethyl acrylate (Acryx C-1 manufactured by Toagosei Co., Ltd.) as a water-insoluble hydrophilic monomer, 10 parts by mass of N-vinyl-2-pyrrolidone (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Example 17

A pressure-sensitive adhesive sheet of Example 17 was prepared in the same manner as in Example 1, except that monomers used were changed to 42.5 parts by mass of 2-ethylhexyl acrylate (2EHA manufactured by Mitsubishi Chemical Corporation) as a water-insoluble hydrophobic monomer, 42.5 parts by mass of methoxyethyl acrylate (Acryx C-1 manufactured by Toagosei Co., Ltd.) as a water-insoluble hydrophilic monomer, 10 parts by mass of N-vinyl-2-pyrrolidone (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Comparative Example 1

A pressure-sensitive adhesive sheet of Comparative Example 1 was prepared in the same manner as in Example 1, except that monomers used were changed to 95 parts by mass of methoxyethyl acrylate (Acryx C-1 manufactured by Toagosei Co., Ltd.) as a water-insoluble hydrophilic monomer and 5 parts by mass of 4-hydroxybutyl acrylate (4-HBA manufactured by Osaka Organic Industry Co., Ltd.) as a hydroxyl group-containing monomer.

### Comparative Example 2

A pressure-sensitive adhesive sheet of Comparative Example 2 was prepared in the same manner as in Example 1, except that monomers used were changed to 95 parts by mass of 2-ethylhexyl acrylate (2EHA manufactured by Mitsubishi Chemical Corporation) as a water-insoluble hydrophobic monomer and 5 parts by mass of 4-hydroxybutyl acrylate (4-HBA manufactured by Osaka Organic Industry Co., Ltd.) as a hydroxyl group-containing monomer.

### Comparative Example 3

A pressure-sensitive adhesive sheet of Comparative Example 3 was prepared in the same manner as in Example 1, except that monomers used were changed to 85 parts by mass of 2-ethylhexyl acrylate (2EHA manufactured by Mitsubishi Chemical Corporation) as a water-insoluble hydrophobic monomer, 10 parts by mass of N-vinyl-2-pyrrolidone (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Comparative Example 4

A pressure-sensitive adhesive sheet of Comparative Example 4 was prepared in the same manner as in Example 1, except that monomers used were changed to 65 parts by mass of 2-ethylhexyl acrylate (2EHA manufactured by Mitsubishi Chemical Corporation) as a water-insoluble hydrophobic monomer, 30 parts by mass of N-vinyl-2-pyrrolidone (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Comparative Example 5

A pressure-sensitive adhesive sheet of Comparative Example 5 was prepared in the same manner as in Example 1, except that monomers used were changed to 90 parts by mass of methoxyethyl acrylate (Acryx C-1 manufactured by Toagosei Co., Ltd.) as a water-insoluble hydrophilic monomer, 5 parts by mass of acrylic acid (AA) (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Comparative Example 6

A pressure-sensitive adhesive sheet of Comparative Example 6 was prepared in the same manner as in Example 1, except that monomers used were changed to 60 parts by mass of methoxyethyl acrylate (Acryx C-1 manufactured by Toagosei Co., Ltd.) as a water-insoluble hydrophilic monomer, 35 parts by mass of acrylic acid (AA) (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Comparative Example 7

A pressure-sensitive adhesive sheet of Comparative Example 7 was prepared in the same manner as in Example 1, except that monomers used were changed to 63.75 parts by mass of 2-ethylhexyl acrylate (2EHA manufactured by Mitsubishi Chemical Corporation) as a water-insoluble hydrophobic monomer, 21.25 parts by mass of methoxyethyl acrylate (Acryx C-1 manufactured by Toagosei Co., Ltd.) as a water-insoluble hydrophilic monomer, 10 parts by mass of N-vinyl-2-pyrrolidone (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Example 18

A pressure-sensitive adhesive sheet of Example 18 was prepared in the same manner as in Example 1, except that monomers used were changed to 10 parts by mass of 2-ethylhexyl acrylate (2EHA manufactured by Mitsubishi Chemical Corporation) as a water-insoluble hydrophobic monomer, 75 parts by mass of methoxyethyl acrylate (Acryx C-1 manufactured by Toagosei Co., Ltd.) as a water-insoluble hydrophilic monomer, 10 parts by mass of N-vinyl-2-pyrrolidone (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Example 19

A pressure-sensitive adhesive sheet of Example 19 was prepared in the same manner as in Example 1, except that monomers used were changed to 25 parts by mass of 2-ethylhexyl acrylate (2EHA manufactured by Mitsubishi Chemical Corporation) as a water-insoluble hydrophobic monomer, 60 parts by mass of methoxyethyl acrylate (Acryx C-1 manufactured by Toagosei Co., Ltd.) as a water-insoluble hydrophilic monomer, 10 parts by mass of N-vinyl-2-pyrrolidone (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Example 20

A pressure-sensitive adhesive sheet of Example 20 was prepared in the same manner as in Example 1, except that monomers used were changed to 10 parts by mass of n-butyl acrylate (BA) as a water-insoluble hydrophobic monomer, 75 parts by mass of methoxyethyl acrylate (Acryx C-1 manufactured by Toagosei Co., Ltd.) as a water-insoluble hydrophilic monomer, 10 parts by mass of N-vinyl-2-pyrrolidone (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Example 21

A pressure-sensitive adhesive sheet of Example 21 was prepared in the same manner as in Example 1, except that monomers used were changed to 25 parts by mass of n-butyl acrylate (BA) as a water-insoluble hydrophobic monomer, 60 parts by mass of methoxyethyl acrylate (Acryx C-1 manufactured by Toagosei Co., Ltd.) as a water-insoluble hydrophilic monomer, 10 parts by mass of N-vinyl-2-pyrrolidone (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Example 22

A pressure-sensitive adhesive sheet of Example 22 was prepared in the same manner as in Example 1, except that monomers used were changed to 10 parts by mass of isononyl acrylate (INAA manufactured by Osaka Organic Industry Co., Ltd.) as a water-insoluble hydrophobic monomer, 75 parts by mass of methoxyethyl acrylate (Acryx C-1 manufactured by Toagosei Co., Ltd.) as a water-insoluble hydrophilic monomer, 10 parts by mass of N-vinyl-2-pyrrolidone (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Example 23

A pressure-sensitive adhesive sheet of Example 23 was prepared in the same manner as in Example 1, except that monomers used were changed to 25 parts by mass of isononyl acrylate (INAA manufactured by Osaka Organic Industry Co., Ltd.) as a water-insoluble hydrophobic monomer, 60 parts by mass of methoxyethyl acrylate (Acryx C-1 manufactured by Toagosei Co., Ltd.) as a water-insoluble hydrophilic monomer, 10 parts by mass of N-vinyl-2-pyrrolidone (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### Comparative Example 8

A pressure-sensitive adhesive sheet of Comparative Example 8 was prepared in the same manner as in Example 1, except that monomers used were changed to 50 parts by mass of isononyl acrylate (INAA manufactured by Osaka Organic Industry Co., Ltd.) as a water-insoluble hydrophobic monomer, 35 parts by mass of methoxyethyl acrylate (Acryx C-1 manufactured by Toagosei Co., Ltd.) as a water-insoluble hydrophilic monomer, 10 parts by mass of N-vinyl-2-pyrrolidone (manufactured by Tokyo Chemical Industry Co., Ltd.) as a water-soluble hydrophilic monomer, and 5 parts by mass of 4-hydroxybutyl acrylate (4-HBA manufactured by Osaka Organic Industry Co., Ltd.) as a hydroxyl group-containing monomer.

### <Measurement of Water Absorption Amount>

Measurement method of water absorption amount: the obtained pressure-sensitive adhesive layer having a thickness of 100 μm was attached to a PET film having a thickness of 50 μm subjected to corona treatment, and cut into a size of 2.5 cm×5 cm, the separator was peeled off to obtain a measurement sample, the measurement sample was immersed in pure water under the following conditions, and then the water absorption amount was calculated from a difference between the mass of the measurement sample after removal of attached moisture with a blower and the mass of the measurement sample before immersion.

Immersion temperature: 23° C.

Immersion time: 5 minutes

### <Measurement of 180° Release Force to Slate Plate>

The 180° release force to a slate plate was measured in the following manner. The results are shown in Tables 1 to 3.

First, the pressure-sensitive adhesive sheet of each example was cut so as to have a width of 20 mm and a length of 10 cm.

Next, a slate standard plate manufactured by Nippon Test Panel Co., Ltd., with a product name “JIS A5430 (FB)” (hereinafter, also referred to as a slate plate) having a thickness of 3 mm, a width of 30 mm, and a length of 125 mm was prepared. The glossy surface of the slate plate was used.

Subsequently, while the prepared slate plate was immersed in water, the slate plate was degassed with an ultrasonic deaerator (BRANSON 3510 manufactured by Yamato Scientific Co., Ltd.) for 1 hour, allowed to stand overnight, and taken out from the water.

Subsequently, water on the slate plate was wiped off, and the pressure-sensitive adhesive sheet (test piece) of each example prepared on the glossy surface was pressure-bonded to the slate plate by one reciprocation of a 2 kg roller, wrapped with a wrap and an aluminum foil, and allowed to stand at 23° C. for the time (1 minute, 5 minutes, 30 minutes) described in Tables 1 to 3. Thereafter, using a tensile tester (Autograph AGS-50NX manufactured by Shimadzu Corporation), the 180° release force (N/20 mm) of the slate plate was measured at a release temperature of 23° C. and a release rate of 300 mm/min.

### <Measurement of 180° Release Force to Mortar Plate>

In the same manner as in the measurement of the 180° release force to the slate plate except that the slate plate was changed to a mortar plate, a mortar plate to which the pressure-sensitive adhesive sheet (test piece) was adhered was wrapped with a wrap and an aluminum foil, and allowed to stand, and the 180° release force (N/20 mm) was measured after 1 minute and 5 minutes.

### <Corrosion Test for Aluminum Plate>

After each pressure-sensitive adhesive sheet was bonded to an aluminum foil having a thickness of 20 μm, and then stored in a high-temperature and high-humidity environment, in which temperature is 85° C. and a humidity is 85%, for 72 hours, discoloration (degree of corrosion) of the bonding surface of the pressure-sensitive adhesive sheet was visually observed and determined.
A: No discoloration of aluminum foil
B: Discoloration of aluminum foil is partially present
C: Discoloration was observed on the entire surface of the bonded portion

### <Measurement of Water Contact Angle>

A liquid droplet of 10 μL was dropped on the pressure-sensitive adhesive surface of each pressure-sensitive adhesive sheet, the water contact angle of the surface of the pressure-sensitive adhesive layer after 5 minutes was measured with a contact angle meter (Dropmaster manufactured by Kyowa Interface Science Co., Ltd.) by a static drop method according to JISR3257.

The materials and evaluation results used in Examples and Comparative Examples are shown in Tables 1 to 3.

TABLE 1

| | | Exam- | Exam- | Exam- | Exam- | Exam- | Exam- | Exam- |
|---|---|---|---|---|---|---|---|---|
| | | ple | ple | ple | ple | ple | ple | ple |
| | | 1 | 2 | 3 | 4 | 5 | 6 | 7 |
| Polymerization method | | UV | UV | UV | UV | UV | Solution | UV |
| Hydrophilic monomer (water-insoluble) | MEA | 90 | 85 | 80 | 70 | 50 | 85 | 90 |
| Hydrophilic monomer (water-insoluble) | Ethoxy-diethylene glycol acrylate | | | | | | | |
| Hydrophilic monomer (water-insoluble) | Methoxy-dipropylene glycol acrylate | | | | | | | |
| Hydrophilic monomer (water-insoluble) | Methoxy-triethylene glycol acrylate | | | | | | | |
| Hydrophilic monomer (water-soluble, | NVP | 5 | 10 | 15 | 25 | 45 | 10 | |
| containing nitrogen) | | | | | | | | |
| Hydrophilic monomer (water-soluble, | HEAA | | | | | | | |
| containing nitrogen) | | | | | | | | |
| Hydrophilic monomer (water-soluble, | ACMO | | | | | | | 5 |
| containing nitrogen) | | | | | | | | |
| Hydrophilic monomer (containing | 4HBA | 5 | 5 | 5 | 5 | 5 | 5 | 5 |
| hydroxyl group) | | | | | | | | |
| Crosslinking agent | HDDA | 0.02 | 0.02 | 0.02 | 0.02 | 0.02 | | 0.02 |
| Crosslinking agent | Coronate L | | | | | | 0.5 | |
| Initiator (pre-polymerization) | Irgacure l84/Irgacure 651 | 0.1/0.1 | 0.1/0.1 | 0.1/0.1 | 0.1/0.1 | 0.1/0.1 | | 0.1/0.1 |
| Initiator | 2,2′-azobisisobutyronitrile | | | | | | 0.2 | |
| Initiator | Irgacure l84 | 0.1 | 0.1 | 0.1 | 0.1 | 0.1 | | 0.1 |
| 180° release force (slate plate) | After 1 minute | 1.55 | 3.45 | 4.12 | 4.33 | 5.66 | 3.11 | 0.11 |
| | After 5 minutes | 6.15 | 6.57 | 6.56 | 6.78 | 6.55 | 5.46 | 0.12 |
| | After 30 minutes | 6.73 | 6.34 | 6.55 | 6.58 | 6.72 | 5.78 | 0.19 |
| 180° release force (mortar plate) | After 1 minute | 5.11 | 9.12 | 10.67 | 11.21 | 11.72 | 4.12 | 2.11 |
| | After 5 minutes | 9.45 | 14.12 | 16.12 | 16.43 | 15.48 | 7.94 | 3.85 |
| Corrosion (for aluminum plate) | Storage at 85° C./85% for 72 hours | A | A | A | A | A | A | A |
| Water absorption amount | After 5 minutes (mg) | 23.3 | 31.2 | 34.5 | 38.8 | 48.1 | 28.4 | 9.8 |
| Water contact angle | Immediately after dripping water | 62.3 | 60.1 | 57.4 | 56.7 | 55.8 | 58.9 | 110.5 |

| | | Exam- | Exam- | Exam- | Exam- | Exam- | Exam- |
|---|---|---|---|---|---|---|---|
| | | ple | ple | ple | ple | ple | ple |
| | | 8 | 9 | 10 | 11 | 12 | 13 |
| Polymerization method | | UV | UV | UV | UV | UV | UV |
| Hydrophilic monomer (water-insoluble) | MEA | 70 | 90 | 70 | | | |
| Hydrophilic monomer (water-insoluble) | Ethoxy-diethylene glycol acrylate | | | | 85 | | |
| Hydrophilic monomer (water-insoluble) | Methoxy-dipropylene glycol acrylate | | | | | 85 | |
| Hydrophilic monomer (water-insoluble) | Methoxy-triethylene glycol acrylate | | | | | | 85 |
| Hydrophilic monomer (water-soluble, | NVP | | | | 10 | 10 | 10 |
| containing nitrogen) | | | | | | | |
| Hydrophilic monomer (water-soluble, | HEAA | | 5 | 25 | | | |
| containing nitrogen) | | | | | | | |
| Hydrophilic monomer (water-soluble, | ACMO | 25 | | | | | |
| containing nitrogen) | | | | | | | |
| Hydrophilic monomer (containing | 4HBA | 5 | 5 | 5 | 5 | 5 | 5 |
| hydroxyl group) | | | | | | | |
| Crosslinking agent | HDDA | 0.02 | 0.02 | 0.02 | 0.02 | 0.02 | 0.02 |
| Crosslinking agent | Coronate L | | | | | | |
| Initiator (pre-polymerization) | Irgacure l84/Irgacure 651 | 0.1/0.1 | 0.1/0.1 | 0.1/0.1 | 0.1/0.1 | 0.1/0.1 | 0.1/0.1 |
| Initiator | 2,2′-azobisisobutyronitrile | | | | | | |
| Initiator | Irgacure l84 | 0.1 | 0.1 | 0.1 | 0.1 | 0.1 | 0.1 |
| 180° release force (slate plate) | After 1 minute | 0.13 | 0.67 | 1.68 | 1.21 | 1.13 | 0.09 |
| | After 5 minutes | 0.08 | 3.31 | 4.11 | 2.55 | 1.67 | 0.17 |
| | After 30 minutes | 0.23 | 3.61 | 4.24 | 3.25 | 1.76 | 0.25 |
| 180° release force (mortar plate) | After 1 minute | 3.13 | 1.55 | 2.44 | 4.67 | 5.78 | 3.41 |
| | After 5 minutes | 4.11 | 6.34 | 7.28 | 10.67 | 11.21 | 5.89 |
| Corrosion (for aluminum plate) | Storage at 85° C./85% for 72 hours | A | A | A | A | A | A |
| Water absorption amount | After 5 minutes (mg) | 17.1 | 14.1 | 31.2 | 38.9 | 31.2 | 17.9 |
| Water contact angle | Immediately after dripping water | 114.5 | 65.6 | 60.3 | 67.1 | 65.9 | 68.5 |

TABLE 2

| | | | | | | Compar- | Compar- |
|---|---|---|---|---|---|---|---|
| | | | | | | ative | ative |
| | | Exam- | Exam- | Exam- | Exam- | Exam- | Exam- |
| | | ple | ple | ple | ple | ple | ple |
| | | 14 | 15 | 16 | 17 | 1 | 2 |
| Polymerization method | | UV | UV | UV | UV | UV | UV |
| Hydrophobic monomer (water-insoluble) | 2EHA | | | 21.25 | 42.5 | | 95 |
| Hydrophilic monomer (water-insoluble) | MEA | 85 | 85 | 63.75 | 42.5 | 95 | |
| Hydrophilic monomer (water-soluble, | NVP | | | 10 | 10 | | |
| containing nitrogen) | | | | | | | |
| Hydrophilic monomer (water-soluble, | NVF (vinyl formamide) | 10 | | | | | |
| containing nitrogen) | | | | | | | |
| Hydrophilic monomer (water-soluble, | NVA (vinyl acetamide) | | 10 | | | | |
| containing nitrogen) | | | | | | | |
| Hydrophilic monomer (water-soluble, | AA | | | | | | |
| acidic) | | | | | | | |
| Hydrophilic monomer (containing | 4HBA | 5 | 5 | 5 | 5 | 5 | 5 |
| hydroxyl group) | | | | | | | |
| Crosslinking agent | HDDA | 0.02 | 0.02 | 0.02 | 0.02 | 0.02 | 0.02 |
| Initiator (pre-polymerization) | Irgacurel84/Irgacure651 | 0.1/0.1 | 0.1/0.1 | 0.1/0.1 | 0.1/0.1 | 0.1/0.1 | 0.1/0.1 |
| Initiator | Irgacurel84 | 0.1 | 0.1 | 0.1 | 0.1 | 0.1 | 0.1 |
| 180° release force (slate plate) | After 1 minute | 2.11 | 3.23 | 2.31 | 2.11 | 0.07 | 0.08 |
| | After 5 minutes | 4.68 | 6.24 | 5.63 | 5.14 | 0.11 | 0.13 |
| | After 30 minutes | 5.89 | 6.58 | 5.85 | 5.67 | 0.09 | 0.13 |
| 180° release force (mortar plate) | After 1 minute | 4.62 | 6.77 | 7.89 | 6.74 | 0.35 | 0.11 |
| | After 5 minutes | 9.56 | 10.89 | 15.34 | 14.12 | 0.51 | 0.13 |
| Corrosion (for aluminum plate) | Storage at 85° C./85% for 72 hours | A | A | A | A | A | A |
| Water absorption amount | After 5 minutes (mg) | 37.8 | 31.3 | 13.1 | 9.6 | 5.7 | 1.6 |
| Water contact angle | Immediately after dripping water | 64.9 | 67.2 | 63.4 | 67.4 | 109.5 | 110.6 |

| | | Compar- | Compar- | Compar- | Compar- | Compar- |
|---|---|---|---|---|---|---|
| | | ative | ative | ative | ative | ative |
| | | Exam- | Exam- | Exam- | Exam- | Exam- |
| | | ple | ple | ple | ple | ple |
| | | 3 | 4 | 5 | 6 | 7 |
| Polymerization method | | UV | UV | UV | UV | UV |
| Hydrophobic monomer (water-insoluble) | 2EHA | 85 | 65 | | | 63.75 |
| Hydrophilic monomer (water-insoluble) | MEA | | | 90 | 60 | 21.25 |
| Hydrophilic monomer (water-soluble, | NVP | 10 | 30 | | | 10 |
| containing nitrogen) | | | | | | |
| Hydrophilic monomer (water-soluble, | NVF (vinyl formamide) | | | | | |
| containing nitrogen) | | | | | | |
| Hydrophilic monomer (water-soluble, | NVA (vinyl acetamide) | | | | | |
| containing nitrogen) | | | | | | |
| Hydrophilic monomer (water-soluble, | AA | | | 5 | 35 | |
| acidic) | | | | | | |
| Hydrophilic monomer (containing | 4HBA | 5 | 5 | 5 | 5 | 5 |
| hydroxyl group) | | | | | | |
| Crosslinking agent | HDDA | 0.02 | 0.02 | 0.02 | 0.02 | 0.02 |
| Initiator (pre-polymerization) | Irgacurel84/Irgacure651 | 0.1/0.1 | 0.1/0.1 | 0.1/0.1 | 0.1/0.1 | 0.1/0.1 |
| Initiator | Irgacurel84 | 0.1 | 0.1 | 0.1 | 0.1 | 0.1 |
| 180° release force (slate plate) | After 1 minute | 0.09 | 0.17 | 0.24 | 0.36 | 0.18 |
| | After 5 minutes | 0.15 | 0.19 | 0.36 | 1.66 | 0.26 |
| | After 30 minutes | 0.27 | 0.41 | 0.44 | 3.11 | 0.55 |
| 180° release force (mortar plate) | After 1 minute | 0.34 | 0.41 | 1.13 | 3.41 | 0.45 |
| | After 5 minutes | 0.34 | 0.34 | 1.21 | 7.46 | 0.59 |
| Corrosion (for aluminum plate) | Storage at 85° C./85% for 72 hours | A | A | B | C | A |
| Water absorption amount | After 5 minutes (mg) | 5.6 | 6.7 | 4.4 | 6.7 | 7.6 |
| Water contact angle | Immediately after dripping water | 107.4 | 98.9 | 96.7 | 91.8 | 74.7 |

TABLE 3

| | | Example | Example | Example | Example | Example | Example |
|---|---|---|---|---|---|---|---|
| | | 2 | 18 | 16 | 19 | 17 | 20 |
| Polymerization method | | UV | UV | UV | UV | UV | UV |
| Hydrophilic monomer (water- | MEA | 85 | 75 | 63.75 | 60 | 42.5 | 75 |
| insoluble) | | | | | | | |
| Hydrophilic monomer (water- | NVP | 10 | 10 | 10 | 10 | 10 | 10 |
| soluble, containing nitrogen) | | | | | | | |
| Hydrophilic monomer | 4HBA | 5 | 5 | 5 | 5 | 5 | 5 |
| (containing hydroxyl group) | | | | | | | |
| Hydrophobic monomer (water- | 2EHA | | 10 | 21.25 | 25 | 42.5 | |
| insoluble) | | | | | | | |
| Hydrophobic monomer (water- | BA | | | | | | 10 |
| insoluble) | | | | | | | |
| Hydrophobic monomer (water- | INAA | | | | | | |
| insoluble) | | | | | | | |
| Crosslinking agent | HDDA | 0.02 | 0.02 | 0.02 | 0.02 | 0.02 | 0.02 |
| Initiator (pre-polymerization) | Irgacurel84/Irgacure651 | 0.1/0.1 | 0.1/0.1 | 0.1/0.1 | 0.1/0.1 | 0.1/0.1 | 0.1/0.1 |
| Initiator | Irgacurel84 | 0.1 | 0.1 | 0.1 | 0.1 | 0.1 | 0.1 |
| 180° release force (slate plate) | After 1 minute | 3.45 | 2.58 | 2.31 | 2.01 | 2.11 | 3.13 |
| | After 5 minutes | 6.57 | 5.99 | 5.63 | 4.21 | 5.14 | 5.89 |
| | After 30 minutes | 6.34 | 6.1 | 5.85 | 4.98 | 5.67 | 5.96 |
| 180° release force (mortar plate) | After 1 minute | 9.12 | 8.29 | 7.89 | 6.47 | 6.74 | 7.41 |
| | After 5 minutes | 14.12 | 24.97 | 15.34 | 19.11 | 14.12 | 17.39 |
| Corrosion (for aluminum plate) | Storage at 85° C./85% for 72 hours | A | A | A | A | A | A |
| Water absorption amount | After 5 minutes (mg) | 31.2 | 17.6 | 13.1 | 12.1 | 9.6 | 18.2 |
| Water contact angle | Immediately after dripping water | 60.1 | 60.6 | 63.4 | 60.2 | 67.4 | 59.1 |

| | | | | | Comparative |
|---|---|---|---|---|---|
| | | Example | Example | Example | Example |
| | | 21 | 22 | 23 | 8 |
| Polymerization method | | UV | UV | UV | UV |
| Hydrophilic monomer (water- | MEA | 60 | 75 | 60 | 35 |
| insoluble) | | | | | |
| Hydrophilic monomer (water- | NVP | 10 | 10 | 10 | 10 |
| soluble, containing nitrogen) | | | | | |
| Hydrophilic monomer | 4HBA | 5 | 5 | 5 | 5 |
| (containing hydroxyl group) | | | | | |
| Hydrophobic monomer (water- | 2EHA | | | | |
| insoluble) | | | | | |
| Hydrophobic monomer (water- | BA | 25 | | | |
| insoluble) | | | | | |
| Hydrophobic monomer (water- | INAA | | 10 | 25 | 50 |
| insoluble) | | | | | |
| Crosslinking agent | HDDA | 0.02 | 0.02 | 0.02 | 0.02 |
| Initiator (pre-polymerization) | Irgacurel84/Irgacure651 | 0.1/0.1 | 0.1/0.1 | 0.1/0.1 | 0.1/0.1 |
| Initiator | Irgacurel84 | 0.1 | 0.1 | 0.1 | 0.1 |
| 180° release force (slate plate) | After 1 minute | 1.91 | 3.49 | 2.11 | 0.09 |
| | After 5 minutes | 3.12 | 6.55 | 2.87 | 0.1 |
| | After 30 minutes | 4.03 | 6.59 | 3.49 | 0.23 |
| 180° release force (mortar plate) | After 1 minute | 5.66 | 9.31 | 5.31 | 0.23 |
| | After 5 minutes | 10.21 | 19.47 | 11.43 | 0.21 |
| Corrosion (for aluminum plate) | Storage at 85° C./85% for 72 hours | A | A | A | A |
| Water absorption amount | After 5 minutes (mg) | 14.4 | 17.1 | 10.4 | 2.2 |
| Water contact angle | Immediately after dripping water | 60.1 | 65 | 71.2 | 79.1 |

The structures of the monomers and crosslinking agents used in Examples and Comparative Examples are shown in Tables 4 to 6.

TABLE 4

| Monomer type | | Structure |
|---|---|---|
| Hydrophobic monomer (water-insoluble) | 2EHA | 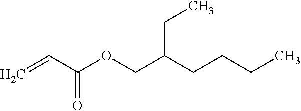 |
| Hydrophobic monomer (water-insoluble) | BA | 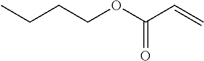 |
| Hydrophobic monomer (water-insoluble) | INAA | 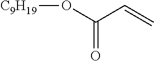 |
| Hydrophilic monomer (water-insoluble) | MEA | 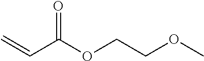 |
| Hydrophilic monomer (water-insoluble) | Ethoxy-diethylene glycol acrylate | 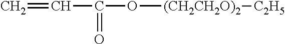 |
| Hydrophilic monomer (water-insoluble) | Methoxy-dipropylene glycol acrylate | 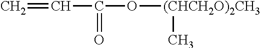 |
| Hydrophilic monomer (water-insoluble) | Methoxy-triethylene glycol acrylate | 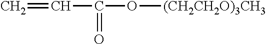 |

TABLE 5

| Monomer type | | Structure |
|---|---|---|
| Hydrophilic monomer (water-soluble, containing nitrogen) | NVP | 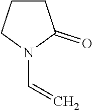 |
| Hydrophilic monomer (water-soluble, containing nitrogen) | HEAA | 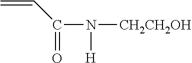 |
| Hydrophilic monomer (water-soluble, containing nitrogen) | ACMO | 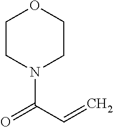 |
| Hydrophilic monomer (water-soluble, containing nitrogen) | NVF (vinyl formamide) | 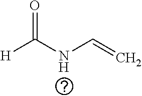 |
| Hydrophilic monomer (water-soluble, containing nitrogen) | NVA (vinyl acetamide) | 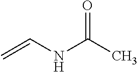 |
| Hydrophilic monomer (water-soluble, acidic) | AA | 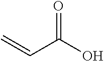 |
| Hydrophilic monomer (containing hydroxyl group) | 4HBA | 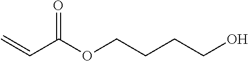 |

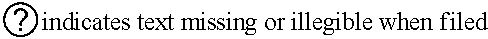

TABLE 6

| Crosslinking agent type | | Structure |
|---|---|---|
| Crosslinking agent | HDDA | 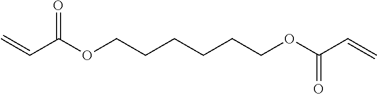 [SMILES: C=CC(=O)OCCCCCCOC(=O)C=C] |
| Crosslinking agent | Coronate L | 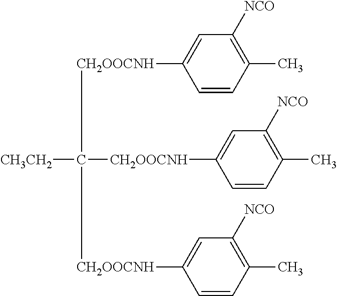 |

In the pressure-sensitive adhesive sheets of Examples 1 to 23, the adhesive force was immediately exhibited to the adherend in a wet state. On the other hand, in Comparative Examples 1 to 4 and Comparative Example 7 in which the water absorption amount of the pressure-sensitive adhesive is small, the adhesiveness is not exhibited regardless of the attachment time. In addition, in Comparative Examples 5 and 6, the adhesiveness to the adherend in a wet state was exhibited, but corrosion of a metal caused by containing an acidic component occurred.

### Example 24

To a four-necked flask equipped with a stirring blade, a thermometer, a nitrogen gas inlet tube, and a cooler, 70.8 parts by mass (100 mol %) of methoxyethyl acrylate (Acryx C-1 manufactured by Toagosei Co., Ltd.) as a water-insoluble hydrophilic monomer, 0.6 parts by mass (1 mol %) of N-vinyl-2-pyrrolidone (manufactured by Tokyo Chemical Industry Co., Ltd.) as a water-soluble hydrophilic monomer, 15.7 parts by mass (20 mol %) of 4-hydroxybutyl acrylate (4-HBA manufactured by Osaka Organic Industry Co., Ltd.) as a hydroxyl group-containing monomer, 0.2 parts by mass of 2,2′-azobisisobutyronitrile as a polymerization initiator, and 300 parts by mass of ethyl acetate were placed, nitrogen gas was introduced while gently stirring, and a polymerization reaction was performed for 7 hours while maintaining the liquid temperature in the flask at around 60° C. to prepare an ethyl acetate solution 2 of an acrylic polymer (solid content concentration: 25%).

Thereafter, 13.5 parts by mass (16 mol %) of methacryloyloxyethyl isocyanate (MOI) was added thereto, and the liquid temperature in the flask was maintained at around 50° C. to perform an addition reaction.

Next, 1.0 part by mass of a trimethylolpropane adduct of tolylene diisocyanate (Coronate L manufactured by Tosoh Corporation) as a crosslinking agent and 1 part by mass of 1-hydroxycyclohexyl phenyl ketone (“Irgacure 184” manufactured by BASF) as a photopolymerization initiator were added to the ethyl acetate solution 2 of the acrylic polymer after the addition reaction, followed by stirring. This mixed solution was applied to a PET film release liner (trade name, “Diafoil MRF”, manufactured by Mitsubishi Chemical Corporation, thickness: 38 μm), and dried by heating at 130° C. for 10 minutes to form a pressure-sensitive adhesive layer having a thickness of 100 μm. Thereafter, a PET film release liner (trade name “Diafoil MRE” manufactured by Mitsubishi Chemical Corporation, thickness: 38 μm) as a cover release film was attached to the surface of the coating layer, and subjected to a heat treatment at 50° C. for 48 hours to prepare a pressure-sensitive adhesive sheet of Example 24.

### Example 25

A pressure-sensitive adhesive sheet of Example 25 was prepared in the same manner as in Example 24, except that monomers used were changed to 67.6 parts by mass (95 mol %) of methoxyethyl acrylate (Acryx C-1 manufactured by Toagosei Co., Ltd.) as a water-insoluble hydrophilic monomer, 3.0 parts by mass (5 mol %) of N-vinyl-2-pyrrolidone (manufactured by Tokyo Chemical Industry Co., Ltd.) as a water-soluble hydrophilic monomer, 15.8 parts by mass (20 mol %) of 4-hydroxybutyl acrylate (4HBA) (4-HBA manufactured by Osaka Organic Industry Co., Ltd.) as a hydroxyl group-containing monomer, and 10.8 parts by mass (16 mol %) of methacryloyloxyethyl isocyanate (MOI).

### Example 26

A pressure-sensitive adhesive sheet of Example 26 was prepared in the same manner as in Example 24, except that monomers used were changed to 57.8 parts by mass (80 mol %) of methoxyethyl acrylate (Acryx C-1 manufactured by Toagosei Co., Ltd.) as a water-insoluble hydrophilic monomer, 12.4 parts by mass (20 mol %) of N-vinyl-2-pyrrolidone (manufactured by Tokyo Chemical Industry Co., Ltd.) as a water-soluble hydrophilic monomer, 16.0 parts by mass (20 mol %) of 4-hydroxybutyl acrylate (4HBA) (4-HBA manufactured by Osaka Organic Industry Co., Ltd.) as a hydroxyl group-containing monomer, and 13.8 parts by mass (16 mol %) of methacryloyloxyethyl isocyanate (MOI).

### Comparative Example 9

A pressure-sensitive adhesive sheet of Comparative Example 9 was prepared in the same manner as in Example 24, except that monomers used were changed to 77.4 parts by mass (100 mol %) of 2-ethylhexyl acrylate (2EHA manufactured by Mitsubishi Chemical Corporation) as a water-insoluble hydrophobic monomer, 12.1 parts by mass (20 mol %) of 4-hydroxybutyl acrylate (4-HBA manufactured by Osaka Organic Industry Co., Ltd.) as a hydroxyl group-containing monomer, and 10.4 parts by mass (16 mol %) of methacryloyloxyethyl isocyanate (MOI).

The 180° release force of the pressure-sensitive adhesive sheets of Examples 24 to 26 and Comparative Example 9 to a SUS plate was measured in the following manner. The results are shown in Table 7.

First, the pressure-sensitive adhesive sheet of each example was cut so as to have a width of 20 mm and a length of 10 cm.

Next, SUS304BA was used for an adherend, and an adherend (SUS plate) having a thickness of 1 mm, a width of 30 mm, and a length of 125 mm was prepared. The surface of the adherend was sufficiently washed with toluene and degreased.

### <Measurement of Release Force Before UV Irradiation (Dry Surface)>

The prepared pressure-sensitive adhesive sheet (test piece) of each example was pressure-bonded to the glossy surface of the dried SUS plate by one reciprocation of a 2 kg roller, and then allowed to stand for 30 minutes.

Subsequently, using a tensile tester (Autograph AGS-50NX manufactured by Shimadzu Corporation), the 180° release force (N/20 mm) of the pressure-sensitive adhesive sheet of each example to the SUS plate was measured at a release temperature of 23° C. and a release rate of 300 mm/min.

<Measurement of Release Force after UV Irradiation (Dry Surface)>

The prepared pressure-sensitive adhesive sheet (test piece) of each example was pressure-bonded to the glossy surface of the dried SUS plate by one reciprocation of a 2 kg roller, and then allowed to stand for 30 minutes.

Subsequently, ultraviolet irradiation (high-pressure mercury lamp, 500 mJ/cm²) was performed for 1 minute.

Subsequently, using a tensile tester (Autograph AGS-50NX manufactured by Shimadzu Corporation), the 180° release force (N/20 mm) of the pressure-sensitive adhesive sheet of each example to the SUS plate was measured at a release temperature of 23° C. and a release rate of 300 mm/min.

### <Measurement of Release Force Before UV Irradiation (Wet Adhesion)>

The degreased SUS plate was immersed in water and taken out from the water.

Subsequently, in a state where moisture remained on the surface of the SUS plate, the pressure-sensitive adhesive sheet (test piece) of each example prepared on the glossy surface was pressure-bonded to the surface of the SUS plate by one reciprocation of a 2 kg roller, and allowed to stand for 30 minutes.

Subsequently, using a tensile tester (Autograph AGS-50NX manufactured by Shimadzu Corporation), the 180° release force (N/20 mm) of the pressure-sensitive adhesive sheet of each example to the SUS plate was measured at a release temperature of 23° C. and a release rate of 300 mm/min.

### <Measurement of Release Force After UV Irradiation (Wet Adhesion)>

The degreased SUS plate was immersed in water and taken out from the water.

Subsequently, in a state where moisture remained on the surface of the SUS plate, the pressure-sensitive adhesive sheet (test piece) of each example prepared on the glossy surface was pressure-bonded to the surface of the SUS plate by one reciprocation of a 2 kg roller, and allowed to stand for 30 minutes.

Subsequently, ultraviolet irradiation (high-pressure mercury lamp, 500 mJ/cm²) was performed for 1 minute.

Subsequently, using a tensile tester (Autograph AGS-50NX manufactured by Shimadzu Corporation), the 180° release force (N/20 mm) of the pressure-sensitive adhesive sheet of each example to the SUS plate was measured at a release temperature of 23° C. and a release rate of 300 mm/min.

TABLE 7

| | | | Comparative | | | |
|---|---|---|---|---|---|---|
| | | | Example 9 | Example 24 | Example 25 | Example 26 |
| Polymer composition | | 2EHA | 100 | | | |
| (mol %) | | MEA | | 100 | 95 | 80 |
| | | NVP | | 1 | 5 | 20 |
| | | 4HBA | 20 | 20 | 20 | 20 |
| | | MOI | 16 | 16 | 16 | 16 |
| Additive composition | | Irgacure l84 | 1 | 1 | 1 | 1 |
| (phr) | | Coronate L | 1 | 1 | 1 | 1 |
| Release | Dry | Before UV | 2.67 | 3.11 | 2.99 | 2.55 |
| force | surface | irradiation | | | | |
| | | After UV | 0.13 | 0.17 | 0.21 | 0.13 |
| | | irradiation | | | | |
| | Wet | Before UV | 0.13 | 0.98 | 1.76 | 1.69 |
| | attachment | irradiation | | | | |
| | | After UV | 0.01 | 0.11 | 0.12 | 0.11 |
| | | irradiation | | | | |

In Table 7, “phr” represents the blending amount (parts by mass) of the additive relative to 100 parts by mass of the polymer.

Although preferred embodiments of the present invention have been described above, the present invention is not limited to the above embodiments, and various modifications and substitutions can be added to the above embodiments without departing from the scope of the present invention.

The present application is based on a Japanese patent application (No. 2020-013774) filed on Jan. 30, 2020, contents of which are incorporated herein by reference.

### REFERENCE SIGNS LIST

10, 30, 40 Pressure-sensitive adhesive sheet
11, 31 Substrate
12, 42 Pressure-sensitive adhesive layer
13 Release liner
32A First pressure-sensitive adhesive layer
32B Second pressure-sensitive adhesive layer
33A, 43A First release liner
33B, 43B Second release liner

1. A pressure-sensitive adhesive composition comprising a base polymer, wherein
the base polymer is a copolymer containing structures derived from a water-insoluble hydrophilic monomer (a) and a nitrogen-containing hydrophilic monomer (b), and a content ratio of the structure derived from the water-insoluble hydrophilic monomer (a) in the base polymer is 40 mass % or more.

2. A pressure-sensitive adhesive composition comprising a base polymer, wherein
a pressure-sensitive adhesive layer formed of the pressure-sensitive adhesive composition has a water absorption amount of 9.0 mg or more as measured by the following method:
Measurement method of water absorption amount: the pressure-sensitive adhesive layer having a thickness of 100 m is attached to a PET film having a thickness of 50 m and cut into a size of 2.5 cm×5 cm to obtain a measurement sample, and the water absorption amount is calculated from a difference between a mass of the measurement sample after immersion in pure water under the following conditions and a mass of the measurement sample before immersion:
Immersion temperature: 23° C.
Immersion time: 5 minutes.

3. The pressure-sensitive adhesive composition according to claim 1, wherein the water-insoluble hydrophilic monomer (a) is at least one selected from methoxyethyl acrylate, ethoxy-diethylene glycol acrylate, methoxy-dipropylene glycol acrylate, or methoxy-triethylene glycol acrylate.

4. The pressure-sensitive adhesive composition according to claim 1, wherein the nitrogen-containing hydrophilic monomer (b) is at least one selected from N-vinyl-2-pyrrolidone, hydroxyethyl acrylamide, acryloyl morpholine, vinyl formamide, or vinyl acetamide.

5. The pressure-sensitive adhesive composition according to claim 1, further comprising a crosslinking agent, wherein the crosslinking agent is at least one selected from a photocuring agent or an isocyanate compound.

6. The pressure-sensitive adhesive composition according to claim 5, wherein the photocuring agent is a photocurable monomer or a photocurable oligomer.

7. A pressure-sensitive adhesive layer formed of the pressure-sensitive adhesive composition according to claim 1.

8. The pressure-sensitive adhesive layer according to claim 7, wherein a swelling degree after immersion in water at 5° C. for 24 hours is 2.5 to 10, and a swelling degree after immersion in water at 23° C. for 24 hours is 1.0 to 2.5.

9. A pressure-sensitive adhesive sheet comprising the pressure-sensitive adhesive layer according to claim 7.

10. The pressure-sensitive adhesive sheet according to claim 9, wherein the pressure-sensitive adhesive layer is formed on a substrate.
